(19) United States
(12) Patent Application Publication
(10) Pub. No.: US 2016/0193094 A1
(43) Pub. Date: Jul. 7, 2016

(54) DEVICE FOR DELIVERING PERSONAL VEHICLES, SUCH AS WHEELCHAIRS OR SCOOTERS, FOR DRIVERS WITH DISABILITIES, AND METHOD FOR IMPLEMENTING SAME

(71) Applicant: Claude BERTRAND, Taradeau (FR)

(72) Inventor: Claude Bertrand, Taradeau (FR)

(21) Appl. No.: 14/912,165

(22) PCT Filed: Aug. 22, 2014
(86) PCT No.: PCT/EP2014/067915

§ 371 Date: Feb. 16, 2016

(30) Foreign Application Priority Data
Aug. 23, 2013 (FR) 1358159
Feb. 3, 2014 (FR) 1450805

(51) Int. Cl. A61G 3/06; A61G 3/08; A61G 7/10; A61G 3/02

(52) U.S. Cl. CPC A61G 3/063; A61G 3/0209; A61G 3/0808; A61G 7/1025; A61G 2203/72

(57) ABSTRACT

A device including a box having an opening at least on one side and containing a personal vehicle and a folding seat, respective transfer locations, in which the personal vehicle and the folding seat are located next to and in close proximity to each other, the movable folding seat being capable of being guided between a forward position close to the motor vehicle seat and the transfer location of same, and a seat intended to support the user and guided between the folding seat and the personal vehicle, when the vehicle and the folding seat are in the respective transfer locations of same.

### CROSS-REFERENCES TO RELATED APPLICATIONS

This application claims priority benefit under 35 U.S.C. §371 to International Patent Application No. PCT/EP2014/067915 entitled DEVICE FOR DELIVERING PERSONAL VEHICLES, SUCH AS WHEELCHAIRS AND SCOOTERS, FOR DRIVERS WITH DISABILITIES, AND METHOD FOR IMPLEMENTING THE SAME, and filed by inventor Claude Bertrand on Aug. 22, 2014. International Patent Application No. PCT/EP2014/067915 claims priority to French Patent Application No. 13 58159, filed by inventor Claude Bertrand on Aug. 23, 2013, and to French Patent Application No. 14 50805 filed by inventor Claude Bertrand on Feb. 3, 2014.

### BACKGROUND OF THE INVENTION

The present invention relates to a device for delivering personal vehicles, such as wheelchairs or scooters, for drivers with disabilities, and a method and use for this device for delivering these vehicles to said drivers.

The autonomy of drivers with disabilities or reduced mobility, i.e., in the context of the present invention, those who are substantially incapable, or have extreme difficulty, in moving on foot, is limited by the absence, in the parking places reserved for them, of effective and inexpensive means for easily delivering a personal vehicle for disabled persons, for example a wheelchair or a scooter, preferably electric, and transferring themselves from, then to their vehicle.

Of course, there are motor vehicles capable of transporting a wheelchair and presenting it to the driver, as well as vehicles including transfer aides, from the seat toward the wheelchair, for example in the form of a retractable jump seat, but these vehicle arrangements are very expensive. When wheelchairs or scooters are provided to drivers, for example in public places, it is practically necessary to have assistant staff for the disabled persons, which is also very expensive.

### SUMMARY

The present invention proposes to resolve these drawbacks and provide a device for delivering personal vehicles, in particular such as a wheelchair or scooter, for drivers with disabilities that is effective, inexpensive, and able to be implemented cost-effectively, allowing simple, safe and effective use for drivers, and that is particularly cost-effective and easy to manage for the entity managing it. Another aim of the invention is to reduce the transfer time for the driver using it between his motor vehicle and the wheelchair or scooter, which in particular makes it possible to reduce his fatigue and exposure time to airborne pollution, for example in confined parking areas.

Within the meaning of the present invention, drivers with disabilities are people with nonexistent or reduced mobility, but who are capable of driving a vehicle, or at least using it, and having enough autonomy to drive a personal vehicle for persons with disabilities. This for example involves paraplegic people or people having lost the use of their legs, or who can only walk with great difficulty, for example people suffering from obesity. This term also encompasses people with normal or only slightly altered mobility, but who tire or lose their breath very quickly.

A personal vehicle for persons with disabilities within the meaning of the present invention in particular refers to wheelchairs, scooters for the disabled and tricycles, driven by the disabled person himself.

The invention relates to a device for delivering personal vehicles to drivers with disabilities, characterized in that it includes:

a box or container of the street furniture type having, at least on one side, an opening that can be opened and closed by closure actuating means controlled by a user, and containing a personal vehicle and a jump seat, positioned in respective positions withdrawn inside the box,

respective transfer locations, preferably inside the box, in which the wheelchair and the jump seat are next to and in close proximity to one another, said personal vehicle, when it is arranged in its transfer location, being kept in that location by fastening means releasable by the user, said movable jump seat being able to be moved over guide means between a forward position situated next to and in the vicinity of the seat of the user's motor vehicle, stopped in its determined position, and its transfer location,

optionally, but preferably, a seat bottom designed to support the user and movable horizontally between a position on said jump seat and a position on said personal vehicle, along respective guide means forming a trajectory allowing it to move when said vehicle and the jump seat are in their respective transfer locations,

optionally, means for guiding and moving the vehicle, simultaneously with the movement of the jump seat, between said positions withdrawn in the box and said transfer locations,

optionally, but preferably, means for detecting the open position of the door of the motor vehicle, causing the movement of the jump seat to stop at a predetermined fixed distance from the car door,

optionally, but preferably, means for driving the jump seat on its guide means and control means related thereto, controllable by the user.

The vehicle is preferably a wheelchair, preferably a motorized wheelchair, in particular an electric wheelchair, or a scooter, preferably electric. Preferably, the vehicle does not include a driver's seat, but a support provided with means to receive and maintain said moving seat bottom, which then forms the seat of the vehicle. This support can have, for example, one or more guides or rails to receive one or more sliders presented by the lower face of the seat bottom, and also serving for positioning of the seat bottom on the jump seat, which itself is provided with similar guides or rails that may align to transfer the seat bottom between the jump seat and the vehicle.

The vehicle, and preferably the jump seat as well, can advantageously be provided with blocking means immobilizing the seat bottom, once it has reached the correct position, on the seat bottom guide means of the personal vehicle, or the jump seat. Particularly preferably, the blocking means are sensitive to the presence of the personal vehicle in its withdrawn position, or its transfer position, if it is different, to allow unlocking of the seat bottom only in that position. Thus, when the vehicle, such as a wheelchair or scooter, leaves this position, said blocking means prevents any movement of the seat bottom, the return to the position allowing unlocking.

In a first, preferred embodiment, the transfer positions of the jump seat and the personal vehicle are situated substantially inside the box. For example, the transfer position of the personal vehicle is also its position withdrawn in the box.

The guide means of the jump seat, for example rails or guideways, are preferably fully contained inside the box.

Various driving means of the jump seat can be used, for example of the rack or worm screw or hydraulic or pneumatic jack type.

In one advantageous embodiment, said forward position of the jump seat is still situated substantially, or even completely, inside the box, the closing means of the box being arranged so that in the open position, the access between the seat of the vehicle and the jump seat in the forward position is freed.

Preferably, the closing means of the box, such as doors or pivoting, tilting or sliding curtains, free an access opening, both on the front of the box and on its lateral side close to the motor vehicle.

Preferably, the withdrawn position of the box also constitutes the transfer location, at least for the wheelchair.

In one preferred embodiment, in particular for a box with reduced dimensions with an opening on both the front of the box and the lateral side where the vehicle is motor stored, the withdrawn position of the jump seat in the box can be situated behind its transfer position toward the wheelchair.

It is advantageously possible to provide, and in particular inside the box itself, or on said surface extending in front of the box, in particular if the transfer positions between the jump seat and the personal vehicle are situated partially or completely outside the box, means for guiding the personal vehicle preferably having a shape facilitating the backward return of the personal vehicle supporting the user, so as to bring it back to the exact transfer location of the personal vehicle, for example, by having slots or channels, to guide the rear wheels of the vehicle, such as a wheelchair or scooter, to that location, these channels possibly widening in a dovetail shape toward the front to facilitate the backward return of the user, on his personal vehicle, when he returns to the transfer location, these guide means also allowing perfect positioning of the personal vehicle, in its position withdrawn in the box, whether this withdrawn position corresponds to the transfer location or is situated more behind the back of the box.

In one embodiment of the invention, the length of the movement of the jump seat to its position situated next to the seat of the motor vehicle can be determined by the detection of the position of the open door of the motor vehicle, for example the detection, by said detection means, of the open position of the door, presented, preferably, by the jump seat or by the box, and causing the stop at a fixed distance from the door.

In another embodiment, this length can be constant, the device then having means allowing the driver of the motor vehicle to move his car door into a predetermined location, the device preferably not being able to be actuated when this location has not been reached.

In one embodiment, in particular in the case where such constant travel or movement of the jump seat is provided, these means can comprise a detector, of a known type, that precisely detects the position of the interstice or slot that is present, just behind the rear edge of the closed door of the motor vehicle, this detector informing a signaling means, for example a signaling light, indicating to the user or driver that the motor vehicle has reached a perfect stop position.

It is in particular possible to provide that the closure of the box cannot be opened without the motor vehicle, or if the latter is positioned incorrectly.

In one embodiment, the guide means for guiding the jump seat between its position withdrawn in the box and its forward position next to the seat of the motor vehicle can extend obliquely toward the side and front of the motor vehicle. In this case, the stop position of the motor vehicle is generally laterally separated from the box by a distance sufficient to allow the opening of the pivoting door of the driver without being bothered or hindered by the presence of the box or furniture.

It is preferred for the guide means of the jump seat be inclined, relative to the motor vehicle axis, by an angle preferably comprised between 50 and 70°, more preferably between 55 and 65°, and preferably approximately 60°, substantially corresponding to the angle of the motor vehicle door in its open position.

In another, preferred embodiment, said guideways are on the contrary substantially parallel, or less oblique relative to the longitudinal axis of the motor vehicle, forming an angle, preferably smaller than 20 or 25 or 30°, with the axis of the device, the stop position of the motor vehicle then preferably being able to be very close to the lateral edge of the box as long as it is axially forward by a sufficient distance to allow the opening of the pivoting door of the driver without being bothered or hindered by the front end of the box, at least when the latter has an opening on both the front and the lateral side where the motor vehicle is stored.

It is possible to provide identification means, guides or ruts on the ground imposing the lateral distance between the device and the driver side, and therefore the seat of the motor vehicle, on the motor vehicle, and axial position identification means, able to be seen by the user in the motor vehicle, of the detector or radar type detecting the axial or lateral stop position.

When the device has a moving seat bottom, in one particularly preferred embodiment, the user can transfer himself to the moving seat bottom of the jump seat, then move the seat bottom toward the personal vehicle. The transfer location of the personal vehicle can be situated just next to the transfer location of the jump seat, or slightly offset toward the rear relative to that of the jump seat situated on its side, the guide means then being able to be inclined, relative to the axis of the vehicle, by an angle preferably comprised between 50 and 70°, more preferably between 55 and 65°, and preferably approximately 60°, substantially corresponding to the angle of the motor vehicle door in its open position.

However, in another embodiment, in particular when the transfer locations are positioned side by side, the guide means of the seat bottom can be perpendicular to the movement axis of the personal vehicle, such as a wheelchair or scooter.

In one embodiment, the guide means for the seat bottom supported by the jump seat allow a movement of the seat bottom partially with the seat bottom partially cantilevered up to the immediate vicinity of the seat of the motor vehicle. It is then optionally possible to provide the jump seat, on one or both of its sides, with means for extending the seat bottom guidance, these means being retractable, for example in the form of a tray pivoting around a horizontal axis.

However, in one preferred embodiment, in particular when the guide means of the jump seat are parallel to the longitudinal axis of the motor vehicle and the box, or slightly oblique, toward the front and toward the seat of the motor vehicle, the jump seat can have a movable jump seat structure, for example a carriage, movable laterally toward the seat of the motor vehicle and provided, at least toward its end on the side of the seat, with support means rolling on the ground, for example casters, this movable structure having guide means for guiding the movement of the seat bottom. Preferably, these guide means can extend so that the seat bottom can slide into the immediate vicinity of the seat, the presence of the support casters ensuring that the weight of the user, coming from the seat onto the seat bottom, does not cause a significant cantilever.

The rolling means are preferably casters, the axis of which is mounted on a rod or arm that can pivot freely around a vertical axis, such that the simple movement of this lateral carriage causes the orientation of the casters in the movement direction.

Preferably, driving means are provided, for example of the rack or worm screw or jack type, for lateral movement of the structure relative to the jump seat base that supports it, as well as the related control means.

The seat bottom itself, if it is present, can be motorized, but it is preferred for its movements on its guide means to be done by the user.

Alternatively, less preferably, in the event the seat bottom of the jump seat is not movable and transferable from the jump seat to the personal vehicle, and vice versa, the jump seat can have, on the lateral side across from the seat of the motor vehicle, a plate that is movable or that pivots between a retracted position and a position extending the seat bottom of the jump seat toward said seat, to facilitate the transfer of the user between the seat and the jump seat. This plate can for example pivot around a horizontal axis, or slide horizontally between a retracted position below the seat bottom of the jump seat and the forward position. Advantageously, locking means, for example by snapping, can keep the plate in its forward position, while being able to be released by the user.

In this case, where the device does not have a movable seat bottom making it possible to transfer the user from the jump seat onto the seat and vice versa, it is possible to provide either a stationary seat bottom specific to the jump seat, or a specific seat bottom movable only on the jump seat, between an offset position in the immediate vicinity of the seat of the motor vehicle and the transfer position in the immediate vicinity of the seat of the personal vehicle.

In this case, the personal vehicle itself has its own fixed seat bottom, the transfer of the user between the jump seat and a wheelchair being done by the user's muscular force.

In one preferred embodiment, the jump seat includes means for vertical movement of the seat bottom, allowing a variation in the vertical level, either of the seat bottom specific to the jump seat, or of the movable seat bottom transferred from the jump seat to the vehicle, and vice versa, at least between two levels, i.e., the seat bottom level of the personal vehicle and the seat level of the motor vehicle, if it is different. These means can comprise electric or hydraulic, or other, means for raising and lowering. Preferably, these means are controlled by the user, by actuating means, preferably manual.

Preferably, if the seat bottom is movable on guide means fixed on the jump seat, the vertical movement means are arranged to raise or lower said guide means.

The surface extending in front of the closing means of the box, and on which the user will travel in the personal vehicle upon leaving the box, can be an attached surface placed on the ground, optionally secured to the box, for example in the form of a base bearing the box and extending in front of the box to form said surface, an edge of which preferably determines the side along which the motor vehicle is stored, but it can also be formed simply by a surface of the ground on which the box is placed.

The movement means of the jump seat, which are controlled, preferably by the user, comprise a movable structure, preferably sliding, for example a carriage, to which the jump seat is fastened, or even making up the jump seat, for its exit and return movement with respect to the box, the structure being driven by motor means, for example of the worm screw or rack or jack type.

Preferably, the personal vehicle, in its withdrawal position, is releasably fixed on a wall or another structure secured to the box, the fastening means of the vehicle being able to be released by the user, when seated on the seat bottom, and the latter resting on the personal vehicle, said fastening means re-fastening the personal vehicle when the user has returned to the transfer location of the personal vehicle.

The jump seat can rest and move on the bottom of the box and preferably also on the surface extending between the box and the motor vehicle. It can for example rest on casters or rollers, preferably guided by guide means, for example rails, while being driven by driving means, for example of the worm screw or rack type. However, it is possible to provide for fastening on the stationary or moving structure cantilevered without touching the ground, but with the drawback of supporting the user's weight while being cantilevered. In the event a seat bottom movable between the vehicle and the jump seat is present, the jump seat can simply be reduced to supports for supporting the guide means of the seat bottom. One will therefore understand that the function of the jump seat is in particular to form support and guidance means for the seat bottom between its position close to the seat of the motor vehicle, or cantilevered just next to the seat, and its position on the personal vehicle.

The surface extending between the box and the motor vehicle in its stopped position cannot include any guide means for the jump seat, the latter for example being able to roll, using the wheels or casters, on the surface, or, in another embodiment, move cantilevered above the surface, while being supported by support means from the inside of the box. In the event the guide means of the jump seat extend obliquely, by an angle more or less close to the opening angle of the door of the motor vehicle, the jump seat will preferably have such support means, for example casters, in its forward part, which will be able to leave the box to come near the seat.

In another particularly preferred embodiment, the forward position of the jump seat can even stay inside the box, the latter than being provided with closing means having a forward opening allowing the movement of the personal vehicle outside the box and its return, and lateral openings on the parking side of the motor vehicle. Preferably, the jump seat then has seat bottom means making it possible to bring the seat closer to the motor vehicle, for example in the form of a movable seat bottom guided laterally or obliquely toward said seat, the seat bottom being able to be specific to the jump seat, or preferably shared by the jump seat and the personal vehicle, scooter or wheelchair, while then being guided between them so as to be transferable.

The seat bottom itself may be motorized, but it is preferred for its movements on its guide means to be done by the user.

In this preferred embodiment, it is preferable for the guide means of the jump seat to be substantially parallel to the longitudinal axis of the motor vehicle, or slightly oblique in the forward direction and with the seat of the motor vehicle, not requiring guide means on the surface outside the box. Furthermore, the means for driving and guiding the jump seat can be arranged laterally, and without geometric superposition, next to the vehicle and its trajectory in the box.

In other embodiments, the surface may have guide or rolling means, for example one or more rails. These means can be permanently present on the surface, or on the contrary, be retractable inside the box.

In one embodiment, the box has, at its base, a floor situated above the actual bottom of the box, so as to leave, between the floor and the bottom, a space in which it is possible to insert driving and/or rolling or guidance means for the jump seat, or part of the jump seat itself, which can thus be placed below the personal vehicle, such as a wheelchair or scooter, resting on this floor, in its transfer position, inside the box. The floor can for example be situated at a height of 20 to 40 cm above the bottom. Preferably, a ramp or an inclined plane is provided in front of the opening of the box for rolling of the vehicle on the ground.

The locking means of the personal vehicle, which can be supported by the vehicle, but which are preferably supported by a structure in the box, or said surface, keep the vehicle immobile in this location, the fastening means being able to be released by the user, once seated in the vehicle. Preferably, these fastening or locking means are actuated automatically once the vehicle reaches said predetermined location.

Preferably, detection means, for example associated with means for immobilizing the vehicle, detect the presence or absence of the vehicle in this transfer location. It is also possible to provide detection of the vehicle model to prevent substitutions.

In another embodiment, not preferred, the jump seat, and any guidance means, can be supported by a horizontal tray sliding between the inside of the box and the surface extending in front of the box toward the motor vehicle.

Preferably, the device according to the invention also includes means for detecting the presence of the motor vehicle, and particularly preferably, means allowing the disabled driver to position his vehicle in the correct position, for example an entry gate and exit gate, and optionally, identification means for the driver, or reliefs for the wheels, for example ruts of the type provided in automatic car wash stations, such that the driver can easily park in a position where his door is positioned suitably relative to said surface extending in front of the closing side of the box, and at a small distance from its edge. These means can either be presented by the device itself, or be associated with it while being fastened on the ground.

Preferably, the device includes means for detecting the open position of the door of the motor vehicle, preferably supported by the jump seat, and which, if a door is present, immobilize the jump seat such that the jump seat can be stopped or brought to a predetermined fixed distance from the open door. In one alternative, in particular to prevent the user seated on the jump seat from obscuring these detection means, it is possible to provide for positioning them in a fixed manner, remotely, for example on the box, in particular at its upper part, to determine the position of the door and cause the jump seat to stop at that predetermined distance.

Said predetermined distance constitutes, just behind the open car door, a free space for the legs of the user seated on the seat bottom during his transfer between the seat of the motor vehicle and the personal vehicle via the jump seat. Preferably, this distance between the jump seat and the door is, on average, comprised between 15 cm and 30 cm, for example approximately 25 cm.

Also preferably, the device includes means for detecting the driver's side of the motor vehicle, which immobilize the jump seat at a sufficient distance from the side of the motor vehicle, for example approximately 10 to 30 cm. The determination of this distance can take into account the possibility of an offset of the moving seat bottom, or the existence of a retractable plate designed to be positioned just next to the seat of the motor vehicle.

It is also possible to provide that the user can control the stopped position of the jump seat himself, in particular in the case of a motor vehicle with a sliding door, the open position of which is not detected, with the understanding that in all cases, the detection of a presence in front of the jump seat will automatically cause it to stop.

These detection means can for example comprise one or more radars, sonar or wireless, of the type used to help vehicles park, preferably positioned on or in the front edge of the jump seat.

The means for detecting the presence on the trajectory of the jump seat, and preferably, also of the personal vehicle, can be used to detect the open position of the door of the motor vehicle, but it is also possible to provide specific detection means for the door, preferably situated on the jump seat.

The device can also comprise means for detecting the presence on the surface swept by the opening and closing movement of the door or closing of the box, in order to block this movement in case of detection.

In one preferred embodiment of the invention, the device may comprise means for detecting the presence of the user on the wheelchair and the jump seat, preventing or blocking any movement of the structure and closing of the box, in case of detection, unless the user is seated on the personal vehicle and the latter is freed from the structure, and preferably, situated away from the surface of the box. Preferably, these detection means are associated with the seat bottom, for example in the form of a weight detector or sensor on the seat bottom.

The device also comprise training means, for example a screen visible by the user, and control means, keyboard or otherwise, allowing him to familiarize himself with the working of the device, in particular to train himself on actuating the personal vehicle, wheelchair or scooter, by simulation.

The power source of the device can be autonomous, for example by a battery charged by photovoltaic means, if the device is arranged outside, or by connection to the electric grid, optionally also by means of the battery in order to guarantee that it works in case of power outage.

In one advantageous embodiment, the device, preferably provided with said base, can be made in a single integral assembly, preferably provided with gripping means, for example poles, and able to be transported, for example on a truck or trailer.

The dimensions of the box are preferably from 1.40 to 1.70 m long, the width of the box preferably being comprised between 1.20 and 1.50 m. The height is preferably comprised between 1.40 and 2.20 m. When the transfer locations of the personal vehicle and the jump seat are situated inside the box, the height thereof is preferably at least equal to 1.70 m above the surface on which the wheelchair travels.

In one particular embodiment where the transfer positions are often at least partially outside the box, in front of it, the device includes:

a moving structure forming means for moving both the personal vehicle and the jump seat, between their respective positions inside the box or container and respective transfer locations outside on its surface extending in front of the closing side of the box, and one side of which extends parallel to and at a small distance from the side of the motor vehicle door by which the user will exit, when the motor vehicle is in a predetermined stop position, transfer locations in which the wheelchair and the jump seat are located next one another and in close proximity to one another, said personal vehicle, when it is positioned at its transfer location, being kept in that location by fastening means releasable by the user, said movable jump seat being able to be moved forward to a forward position situated next to and in the vicinity of the seat of the motor vehicle of the user, stopped in its predetermined position,

preferably, said movable seat bottom, designed to support the user and horizontally movable between a position on said jump seat and a position on said personal vehicle, along the respective guide means forming a trajectory allowing it to move when said vehicle and said jump seat are in their respective transfer locations outside the box,

means for detecting a presence on the trajectory of the jump seat and the personal vehicle maintained by said immobilizing means, preventing and/or blocking their movement, and optionally, that of said closure if a presence is detected,

and control means for said movement means, preferably by the user.

In one particular embodiment, said transfer location of the jump seat also constitutes its forward position next to the seat of the motor vehicle of the user, such that the latter can transfer himself onto a moving seat bottom of the jump seat, then move the seat bottom toward the personal vehicle, the forward transfer location of the personal vehicle then very preferably being offset backward relative to the jump seat situated on its side, the means for guiding the seat bottom then being inclined, relative to the axis of the vehicle, by an angle preferably comprised between 50 and 70°, more preferably between 55 and 65°, and preferably approximately 60°, substantially corresponding to the angle of the door of the motor vehicle in its open position.

However, in another embodiment, the guide means can be perpendicular to the axis of the vehicle, and the movement axes of the jump seat and the personal vehicle, the jump seat then being mounted movably, manually by the user or by motor means controlled by the user, between its forward position next to the seat of the motor vehicle and its transfer location next to the personal vehicle, for example wheelchair or scooter.

In the embodiment providing for simultaneous exit of the jump seat and the personal vehicle outside the box, the movement means of the personal vehicle and the jump seat, preferably controlled by the user, comprise said movable structure, preferably sliding, to which the personal vehicle and the jump seat are fastened for their exit and return movements with respect to the box, the structure being driven by a motor means, for example of the worm screw type, the fastening means for fastening the personal vehicle on the structure being releasable by the user, once the latter is seated on the personal vehicle, for example on a seat bottom, and the latter resting on the personal vehicle, said fastening means re-fastening the personal vehicle once the user has returned to the transfer location of the personal vehicle.

The jump seat can remain permanently fastened to the structure, when the means for guiding the seat bottom are positioned obliquely toward the transfer location of the personal vehicle located offset to the rear relative to the jump seat. However, in the embodiment in which said guide means of the seat bottom are simply perpendicular to the movement axes of the vehicle, the jump seat is preferably mounted and guided movably between its forward position next to the seat of the personal vehicle, and its transfer location next to that of the wheelchair.

Preferably, the structure has a substantially vertical wall, in front of which the vehicle and the jump seat are located, and which, in the forward position, closes the opening passage of the box to prevent any access to the inside.

Preferably, this wall bears temporary fastening means for the vehicle, and permanent fastening means, or optionally temporary, for the jump seat.

The jump seat can rest and move on the bottom of the box and on said surface, while being simply secured to the moving structure that moves, for example by casters on which the jump seat is mounted. However, it is possible to provide for fastening it on the structure, for example said vertical wall, cantilevered without touching the ground. The device can include, on said surface extending in front of the box, guide means of the personal vehicle and/or the jump seat for the movement between the inside and the outside of the box.

The blocking means of the personal vehicle, which can be supported by the vehicle, but which are preferably supported by the structure, or said surface, keep the vehicle immobile in this location, these fastening means being able to be released by the user, once the latter is seated in the personal vehicle. Preferably, these fastening or blocking means are actuated automatically once the vehicle reaches said predetermined location.

Said movable structure can optionally include a horizontally movable tray. The device then includes:

said box or container having, on one side, a closure able to be opened or closed by a closure actuating means controlled by a user,

a tray moving, in a guided manner, between an inner position of said box and a horizontal outer position in front of the closure side of the box, by means for actuating the tray controlled by the user, such that one side of the tray can extend parallel to and at a small distance from the side of the door of the vehicle by which the user will exit,

the vehicle, scooter or wheelchair positioned in a predetermined location on the tray and kept in that location by immobilization means releasable by the user,

the movable jump seat in the guide means of the tray extending between a rear location situated next to this predetermined location of the wheelchair, and a forward location situated next to the seat of the user's vehicle,

and means for detecting a presence on the trajectory of said tray and means for detecting a presence on said tray, preventing and/or blocking any movement of the tray, and optionally, said closing if a presence is detected.

Preferably, the device generally includes a base designed to be placed or fixed on the ground, and receiving said box, and having, in front of the closure side thereof, a surface on which the tray moves, said surface preferably extending past the end of the tray, to form an area on which the user can move on said wheelchair when he leaves or returns to the tray. Preferably, at least one edge of this base, by which the user leaves the base or returns to it, is beveled to facilitate the movement of the wheels of the wheelchair.

Advantageously, the tray and the base can cooperate by guide means, for example one or more rails, in the extension of guide means situated on the floor of the box, to horizontally guide the tray over its path. The presence detection means on the path make it possible to prevent any movement of the tray, if there is a human presence or other obstacle on its path between its withdrawn position in the box and its forward position.

These means can for example comprise one or more radars, sonar or wireless, of the type used in motor vehicles for parking assistance, preferably positioned on or in the front edge of the tray.

It is also possible to provide a central detector situated at the apex of the box, and which detects any presence or obstacle, in front of the box or, in particular on the area situated after the central part of the base, to prevent the opening or closing of the door in case of obstacle or presence in that area.

Likewise, the means for detecting a presence on the tray make it possible to prevent any movement of the tray, in case of human presence or another obstacle on the tray.

These means can for example comprise a weight sensor sensitive to the presence of an excess weight relative to the normal weight of the tray with its wheelchair.

It is further preferable to provide, in the box itself, a detector for animal and human presence inside the box, preventing any closure or blockage in the closed position of the box closure. Such detectors are also now commercially available.

The jump seat can be mounted, pivoting or not, on a rolling base, preferably guided by one or more rails of the tray. The trajectory of the jump seat extends, preferably straight, between a forward position, in which it is positioned at a small distance next to the seat of the disabled user's vehicle, and a withdrawn position, in which it is located outside the trajectory traveled by the door of the motor vehicle stopped in the correct position.

The trajectory of the jump seat is preferably limited so that in the withdrawn position, it is nevertheless manually accessible by the user seated in his vehicle. The trajectory of the jump seat can be substantially parallel to and a small distance from the edge of the tray along which the personal vehicle is stored, but alternatively, it may be inclined moving away from that edge toward the rear.

The length of the trajectory of the jump seat is preferably at least equal to 0.8 m, for example, an approximately from 0.90 to 1.20 m, and preferably approximately 0.95 m.

It is possible to provide guide means of the tray in order to guide the wheelchair toward said predetermined location.

The device according to the invention can be completed by one or more other boxes, preferably situated or alongside in front of the box of the device or on the opposite side therefrom where the motor vehicle of the user is parked, and designed for disabled users, but having sufficient independence to move between a motor vehicle and a personal vehicle, such as a scooter or motorized wheelchair. Such a box has a movable structure similar to that of the device, making it possible to deliver and take back the personal vehicle, but without a jump seat. Additionally, the vehicle may not have a movable seat bottom, but a standard fixed seat bottom. The jump seat being absent, the width of the box may be cut in half, such that it is for example possible to position two scooter boxes in front of that of the device, the two closures of these boxes opening toward the front of the device.

Such an additional box may have, on one side, a closure capable of being opened or closed by a closure actuating means controlled by a user, and containing a personal vehicle, in particular a scooter for a person with disabilities, positioned in a position withdrawn inside the box, the device having:

means for moving the personal vehicle between said position inside the box and the transfer location on the outside over a surface extending in front of the closure side of the box, accessible to the user,

said personal vehicle, when it is positioned in its transfer location, being kept in that location by fastening means releasable by the user,

means for detecting a presence on the trajectory of the vehicle maintained by said immobilization means, preventing and/or blocking movement if a presence is detected,

and control means for said movement means.

This device also preferably comprises means for detecting the presence or absence of the securing of the personal vehicle relative to the sliding structure, which can advantageously have a tray on which the vehicle rests.

The invention also relates to a method for using the device according to the invention, in the forms and embodiments described above, for the delivery of personal vehicles, in particular wheelchairs or scooters for persons with disabilities, to said drivers with disabilities, in which, once the device is in place, placed or fixed on a floor, for example by placement of the base on the floor, and connected, if necessary, to the power sector, each user is assigned control means, for example a code to which a keypad is sensitive or a digicode accessible to the user in his motor vehicle, or using a remote control, detectable by sensor means positioned on the device or in the immediate vicinity thereof, and sensitive to the control means when it is in close proximity, the device according to the invention being associated with computerized management means providing:

the detection of the presence of the motor vehicle,

the detection of the open position of the open car door, relative to the device,

the detection of an obstacle or any presence on the surface traveled by the trajectory of the jump seat and/or the trajectory of the closure(s),

the opening of the box,

the exit of the jump seat, then its immobilization in its forward position,

the detection of the presence of the user on the seat bottom situated on the jump seat,

the return of the jump seat, then its immobilization in its transfer location next to the personal vehicle,

the detection of the presence of the user on the seat bottom, situated on the personal vehicle,

the release of the personal vehicle and the observation of the departure of the personal vehicle from its predetermined location, and from the box,

optionally, the closure of the box.

Advantageously, the method also includes the return steps from the user, ensuring:

the detection of the return of the user near the device,

if applicable, the detection of an obstacle or any presence on the surface traveled by the trajectory of the jump seat and/or the trajectory of the closure(s), and the opening of the box,

the detection of the return of the personal vehicle and its immobilization in its transfer location,

the detection of the presence of the user on the seat bottom situated on the jump seat,

the detection of an obstacle or any presence on the surface traveled by the trajectory of the jump seat and/or the trajectory of the closure(s),

the exit of the jump seat, then its immobilization in its forward position,

the detection of the absence of the user on the seat bottom situated on the jump seat,

the return of the jump seat to its position withdrawn in the box,

the closure of the box.

These management means can be situated remotely and communicate with the detectors, sensors and motor means of the device, through a wired or wireless network, for example Wi-Fi, but it is preferred to group them together into one computing unit in the box of the device, this unit further being able to communicate with a central processing unit situated remotely and providing the management of a fleet of devices according to the invention, and in particular while being informed of each operating phase of the device, and any malfunctions. Optionally, this central processing unit can manage audio and/or visual communication means by cameras and screens for user assistance.

The invention also relates to a method for managing a set or fleet of devices, in which a remote control means is made available exclusively to the driver using it, making it possible to actuate the specific device and use it for a predetermined length of time.

Preferably, this remote control means is of the manual remote control unit type, or remote-control card type, or even mobile telephone type comprising a remote control application with a corresponding menu and implementing a control installation of this device. Preferably, this remote control means will make it possible to uniquely identify the user to thus associate him with the device assigned to him. Preferably, for example, the use of the Designation Number, provided by the telephone network or Internet, may be used as a way of authenticating the user at a lower cost.

### BRIEF DESCRIPTION OF THE DRAWINGS

Other advantages and features of the invention will appear upon reading the following description, done as a non-limiting example, and in reference to the appended drawing, in which:

FIG. 1 shows a diagrammatic perspective view of a transportable device according to the invention,

FIG. 2 shows a diagrammatic top view of the inside of the box of this device,

FIG. 3 shows a diagrammatic elevation view of a main carriage of a jump seat on its rails,

FIG. 4 shows a diagrammatic elevation view of this jump seat,

FIG. 5 shows a diagrammatic elevation view of this jump seat in the assembled seat bottom position,

FIG. 6 shows a diagrammatic profile view of this jump seat,

FIG. 7 shows a view similar to FIG. 6 with its lateral carriage out,

FIG. 8 is a view similar to FIG. 6 in the assembled position of the seat bottom,

FIGS. 9 and 10 show perspective views of the jump seat with different orientations of the casters of the lateral carriage,

FIGS. 11 and 12 show diagrammatic top views of the device upon the arrival of the motor vehicle of a user with disabilities,

FIGS. 13 to 22 show diagrammatic top views of the different steps of the transfer of the user from the arrival of his motor vehicle to his departure in a wheelchair,

FIG. 23 shows a perspective view of a control unit of the device that can be actuated by the user from his motor vehicle,

FIG. 24 shows a top view of the base of a device according to another embodiment,

FIG. 25 shows a diagrammatic perspective view of this base,

FIGS. 26 and 27 show diagrammatic profile and elevation views of a jump seat carriage in this embodiment,

FIGS. 28 to 33 show diagrammatic views of this base with the different positions of the jump seat,

FIGS. 34 to 42 show diagrammatic top views of the different steps of the transfer of the user from the arrival of his motor vehicle to his departure in a wheelchair, for this other embodiment of the device,

FIG. 43 shows a diagrammatic top view of the inside of a box or container of another embodiment,

FIGS. 44 and 45 show a diagrammatic profile view of the wheelchair in its withdrawn position, its position outside the box, respectively,

FIGS. 46 to 55 show diagrammatic top views of the different steps of transferring a user from the arrival of his motor vehicle to his departure in a wheelchair,

FIG. 56 shows a perspective view of two additional boxes for delivering scooters, in front of the box of the device,

FIGS. 57 to 60 shows successive top views of the device during the arrival, transfer and temporary departure phases of the user in the wheelchair, in one embodiment comprising a movable tray bearing the jump seat and the personal vehicle.

### DETAILED DESCRIPTION

In the following description, the personal vehicle is described in the form of a wheelchair. It is to be understood that the description can be transposed to any other type of vehicle, in particular scooters for disabled persons, subject to dimensional or other modifications, completely within the immediate reach of one skilled in the art.

Likewise, one skilled in the art has the locations, motors, controls, mechanisms, electric and electronic circuits, computer and transmission hardware, detectors and sensors of all standard natures, described diagrammatically, readily available.

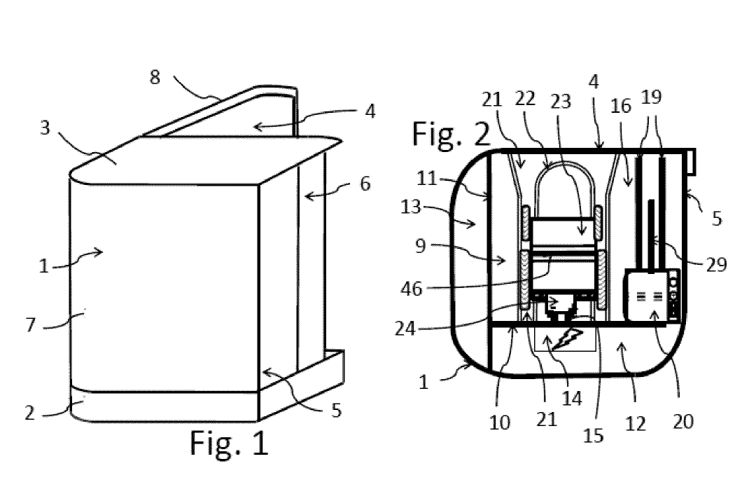

FIG. 1 shows a box 1 of the device having, on the hollow base 2, vertical walls topped by a planar cover 3. In front of the box is an opening that can be closed by a pivoting door 4. The lateral side 5 on the side of the stop position of the motor vehicle includes, toward the door opening 4, a closure or retractable or sliding door 6 able to slide toward the rear 7 of the box. The device can optionally include a fixed partition 8 extending the lateral side of the box opposite the side 5, to protect the door 4 during its opening.

The dimensions of the different parts of the device are for example as follows:

box length: approximately 1.70 m,

box width: approximately 1.40 m,

box height: approximately 1.90 m.

Consequently, it is possible to place these devices in any desired location, for example in outdoor or underground parking areas, in shopping mall or hospital parking lots, etc.

FIG. 2 shows, in top view, the bottom of a box 1, similar to that of FIG. 1, but with no base 2, replaced by a simple horizontal bottom wall 9 placed and fixed on the ground of the parking lot, for example. The inside of the box is subdivided by vertical partitions 10, 11, defining a rear space 12 and a side space 13. The space 12 contains electricity supply means 14, for example of the transformer-battery type, or inverter type, tuned to the electric grid, and capable of delivering a battery recharge current through connection means 15 supported by the partition 10 and extending through the latter, in the space 16 situated on the other side of the partition 10.

It is preferable that, for the box dimensions specified above, the width of the rear space 12 not exceed 0.40 m, and for that of the side space 13 not to exceed 0.40 m.

The bottom 9 of the box has two guide rails 19, extending axially to the immediate vicinity of the pivoting door 4 of the box 1, and supporting and guiding a jump seat 20 assembly, the standby operating location of which is situated near the partition 10. Parallel to the rails, and toward the side having the partition 11, two ruts 21 extend, defined by metal sheets or ribs 22 fastened on the bottom 9. A motorized personal vehicle 23, in the case at hand a motorized wheelchair for a disabled person, rests in these ruts, and is provided with its own steering and braking means, whereof the transfer, and standby, location is situated near the partition 10, in which position the battery 24 of the wheelchair 23 is connected to the connecting means 15 to be recharged. The armrests of the wheelchair are hinged to be able to be raised and lowered, as is standard. The wheelchair includes a chassis with large rear driving wheels and small front steering wheels, and with a backrest (not shown).

One can see that the ruts 21 flare on the side of the pivoting door 4, for the exit and return, moving backwards, of the wheelchair 23, whereas toward the partition 10, the ruts become narrower to guide the rear wheels of the wheelchair precisely, so as to allow the electrical connection with the connecting means 15, as well as the immobilization of the wheelchair by immobilizing means, for example jaws (not shown) releasable by the user.

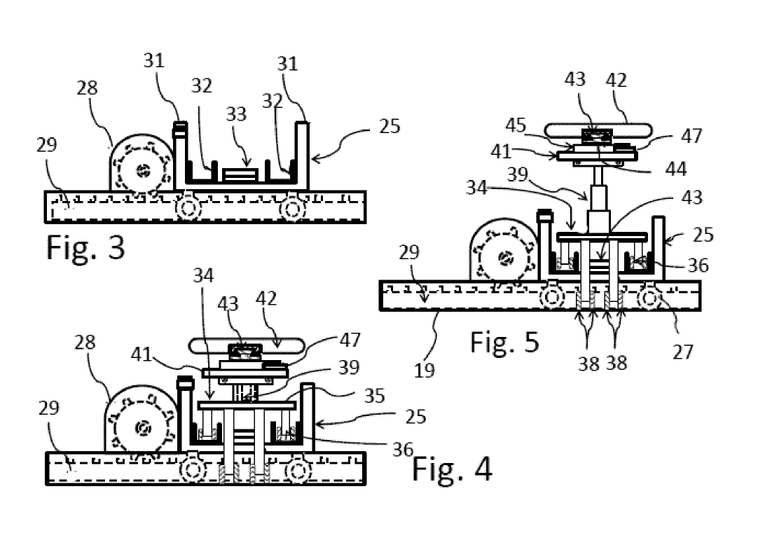

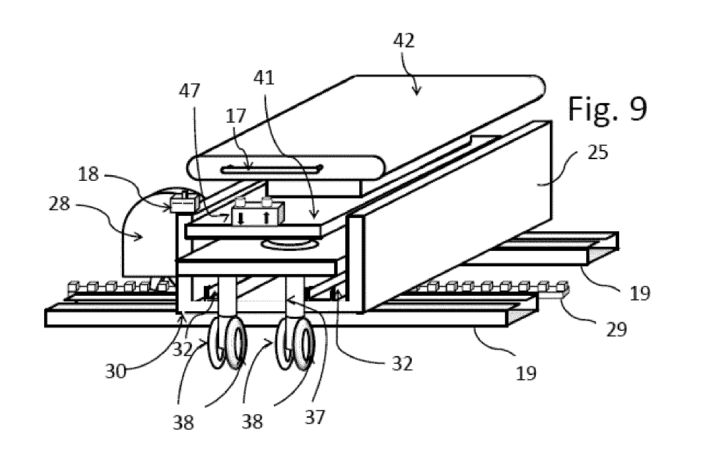

Reference will be made to FIGS. 3 to 10, describing the jump seat assembly 20.

This jump seat includes a carriage 25 resting on four feet 26 provided with casters 27 guided in the rails 19 with a C-shaped cross-section, preventing their upward removal. The carriage 25 can be driven in its travel on the rails by motor means with a notched wheel 28 cooperating with a rack 29 fixed on the bottom 9, preferably between the rails 19. The carriage 25 includes a base 30 and two front and rear wings 31. The base 30 supports two rails 32, with a U-shaped section, extending transversely to the axial direction of the rails 19, as well as a rack 33 parallel to the rails 32.

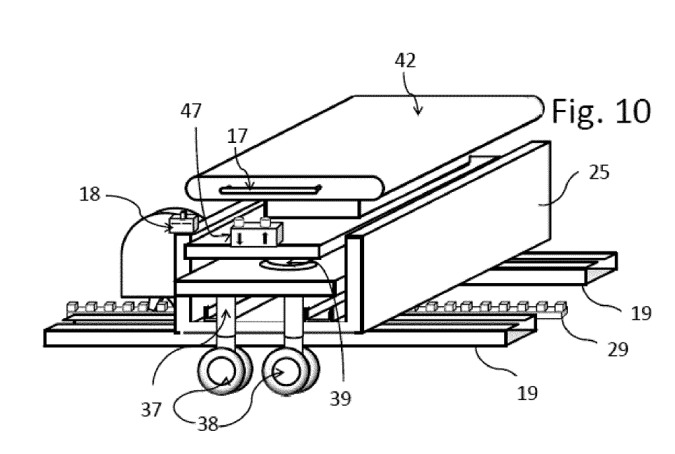

The jump seat also includes a second carriage 34, movable transversely relative to the carriage 25, including a base 35, mounted at one end on rollers 36 rolling in the rails 32, and at the other end, close to the motor vehicle, two feet 37, bearing casters 38 designed to roll on the ground. These casters 38 can pivot around vertical axes (not shown), which allows them to orient themselves in all directions, depending on whether their carriage 34 moves axially through the movement of the carriage 25, or transversely with the motor vehicle, as shown in FIGS. 9 and 10. It will also be understood that the carriage 34 can pivot slightly in the vertical plane, to adapt to the small surface variations of the ground, if they exist, when the carriage moves laterally toward the motor vehicle seat. In order to prevent a risk of upward removal, it is possible to provide the rails 32 have a C-shaped section, preventing the removal from the rollers 36 in the upward direction. The base 35 also bears motor means with a notched wheel (not shown) to cooperate with the rack 33 supported by the carriage 25.

The tray 35 of the carriage 34 bears two electric lifting jacks 39 making it possible to lower and raise a plate 40 bearing a tray 41 extending above the base 35, and over its entire length, in the transverse direction.

The jump seat 20 can have a proximity detector, of a type commonly used in motor vehicles for parking assistance. This detector is functionally connected to control means of the motor 28 to cause it to stop 25 cm away from any detected obstacle. It is in particular oriented to detect the open door of the user's motor vehicle, and stops at that distance from the car door.

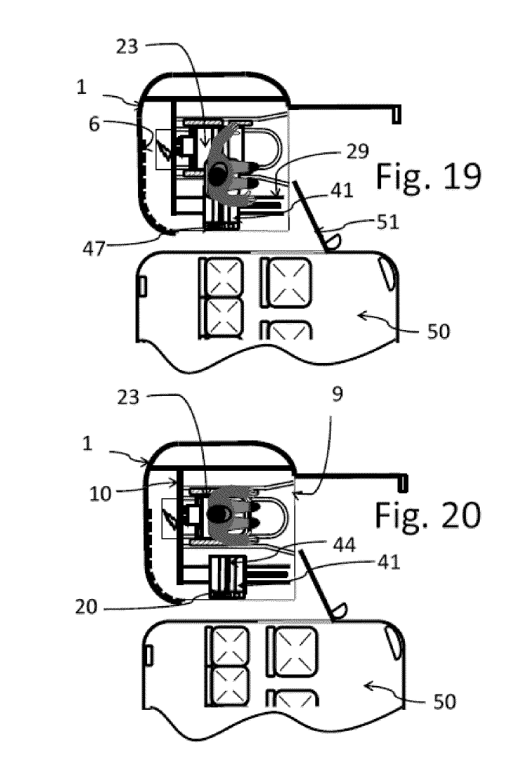

The jump seat 20 and the wheelchair 23 do not have their own seat bottoms, but a seat bottom 42 transferable between them. The seat bottom 42, the upper surface of which may have a comfort cushion, like a seat, and optionally a backrest, is mounted on a slider 43 allowing the seat bottom to slide easily on the guideway 44, with a section for example in a dovetail shape preventing the lifting of the seat bottom, this guideway being fastened on an intermediate part 45 secured to the tray 41. More specifically, the jump seat and the wheelchair respectively bear a guideway 44, 46 (FIGS. 2 and 18) that can receive the seat bottom and allow it to slide. When the wheelchair and the jump seat are in their respective transfer locations, the guideways 44, 46 are aligned, as shown in FIGS. 18 and 19, which allows the user, by moving the seat bottom 42 on which he is seated, to transfer the seat bottom from the jump seat to the wheelchair and vice versa. The length of the side 43 secured to the seat bottom is such that the partial cantilever that occurs when the seat bottom crosses the space separating the respective guideways does not prevent the seat bottom from staying in its horizontal position perfectly aligned with the guideways. Preferably, the ends of the guideways 44, 46 and/or the slider are beveled or otherwise arranged so that the ends of the guideways easily accommodate the slider 43, during the passage of the jump seat 20 to the wheelchair 23 and vice versa.

The tray 41 can preferably have, at its end on the side of the door, a flexible contact detector 17 that causes the movement of the transverse carriage 34 to stop when it comes into contact with the motor vehicle, in particular its seat. Near the detector, the carriage bears one or more control units 18, 47 comprising the usual respective control buttons or levers, controlling:

the forward and backward movements of the carriage 25,

the movements toward and from the motor vehicle of the carriage 34,

the upward and downward movement of the seat bottom, via the jacks 39.

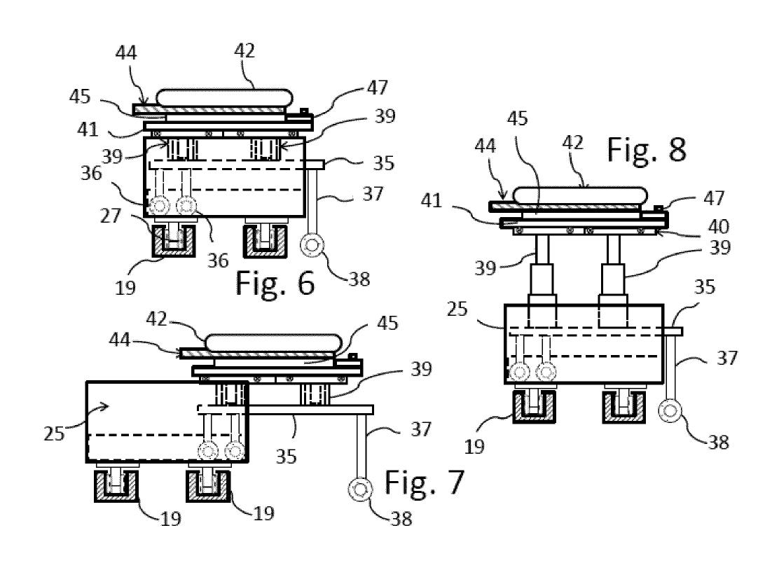

As shown in FIGS. 6 to 10, the unit 47, with its buttons, is accessible to the user's right hand, when the seat bottom 42 is in its idle position, but disappears below the seat bottom when it is slid by the user into contact with or into the immediate vicinity of the seat of the motor vehicle, preventing the user from maneuvering the carriages in an untimely manner during his transfer between the seat bottom and the seat. Alternatively, it is also possible to provide an electric contact actuated by the siding of the seat bottom, to turn off the control unit when the seat bottom laterally approaches the motor vehicle.

The device shown in the Figures can also include different power supply, computerized management and communication means with a control center located elsewhere and/or the vehicle and/or the user, these means preferably being situated on or in the body. These means, the acquisition and implementation of which are readily available to one skilled in the art, can comprise:

the battery 14 associated with an inverter directly connectable to a power outlet for the sector of the location, parking lot or premises, or where the device is installed, this battery preferably powering all of the electric and computer devices of the device,

the motors of the driving means relative to the jump seat,

at least one motor (not shown) for actuating a door or closure of the box 1,

the battery 24 of the vehicle, via the connectors 15 ensuring the electrical connection when the vehicle 23 is in its withdrawn position,

preferably, a presence detector on the outer surface before opening of the door(s), for example an infrared sensor, for example available from the companies BALUFF or MICROSONIC (German origin) or EXTRONIC (SWEDISH origin),

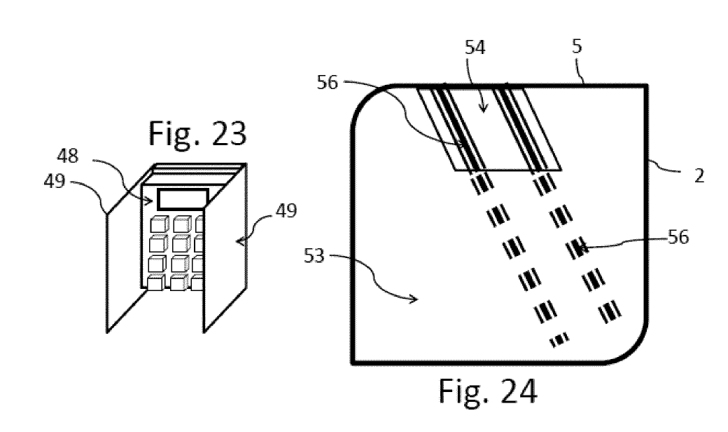

preferably a control unit 48 (FIG. 23), for example with a keyboard, mounted accessibly to the user seated in his motor vehicle, preferably on the edge of a door 4 or 6 of the box, preferably between two protruding edges 49 that conceal the keyboard from the user, if he is not seated, on his seat, substantially in the desired stop location of the motor vehicle,

means for detecting the fixed or released state of the personal vehicle with respect to the wall 10, for example by simple electric contacts, and preferably identification means of the personal vehicle, or even the user, for example using a remote card reader system, for example by the companies BALUFF and MICROSONIC (German origin) or EXTRONIC (Swedish origin),

preferably, a camera allowing an operator situated remotely to view the device and the motor vehicle, and/or a microphone-speaker system to communicate with the user,

optionally, one or more gate actuating motors for one or more gates in front of and/or behind the motor vehicle parked next to the box and/or signal lights,

the door radar or detector, preferably ultrasound detector, for example available from the companies BALUFF or MICROSONIC (German origin) or EXTRONIC (SWEDISH origin), this detector being able to be fixed to the front end of the jump seat, but preferably on the box, for example at the apex and front of the box, so as not to risk being obscured by the user seated on the jump seat,

preferably, means for detecting the position of the seat bottom, in particular its position on the jump seat and its position on the wheelchair or personal vehicle, for example by electric contacts sensitive to the passage of the seat bottom,

optionally, means for blocking the seat bottom on the jump seat and/or on the vehicle,

means for detecting the presence or absence of the driver on the seat bottom, for example a sensor sensitive to the weight of the seat bottom, or an electric contact actuated by a vertical movement or a deformation of the seat bottom, for example of the type used for motor vehicle seats,

means for controlling the locking and unlocking of the seat bottom, for example of the type with an electric contact or triggered by mechanical contact, releasing the seat bottom locking means supported by the personal vehicle when the latter is in returns to the personal vehicle transfer position,

preferably, computer means for processing signals received by the various sensors or detectors and implementing different delivery and return phases of personal vehicle.

The device can also include an automatic entry gate, positioned laterally at the edge of the front end of the box, and an exit gate, positioned slightly past the rear edge of the box, these gates being able to be completed by signal lights.

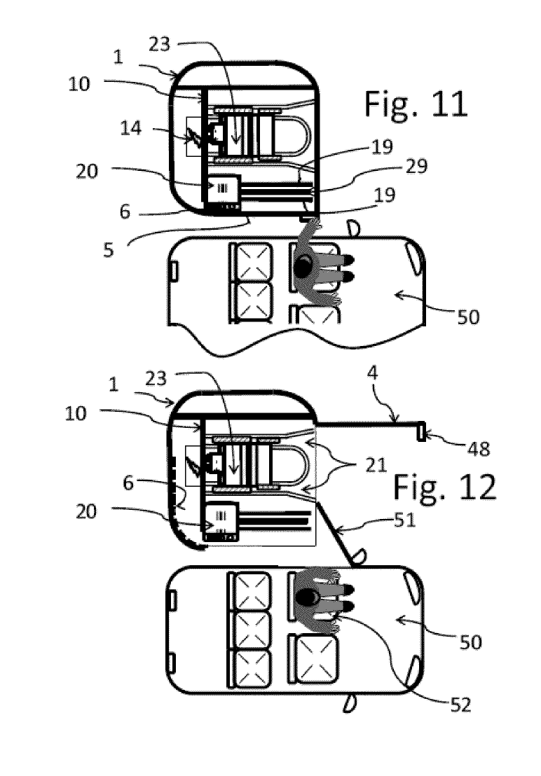

Reference will now be made to FIGS. 11 to 22.

Initially, the box 1 is closed and the jump seat 20, which bears the seat bottom 42, and the wheelchair 23 are contained in the box 1 in their respective idle positions, against the wall 10, as shown in FIG. 2.

The motor vehicle 50 of the user is stored on the right lateral side of the box, in the position of FIG. 11. To that end, it is possible to provide that the floor has, at a suitable distance from the edge 5 of the box, for example approximately 25 cm, a rut parallel to the edge 5. By engaging its left wheels in this rut, it stops, if needed after maneuvering forward or backward, so as to see, on its side, the keyboard of the control unit 48, shown in FIG. 23, without its view being hindered by the two protruding edges 49 of the unit. He then opens his window and presses the opening control button of the unit 48, causing the pivoting door 4 and the retractable door 6 to open. In the event the user has already opened his door, the open position of the door will have been detected by ultrasound sensor situated at the apex of the box, and causing prevention of the opening of the doors 4 and 6, and the sending of a warning signal to the driver.

The user then opens his door 51 (FIG. 12). Preferably, the opening of the door is then detected, for example, by this same sensor.

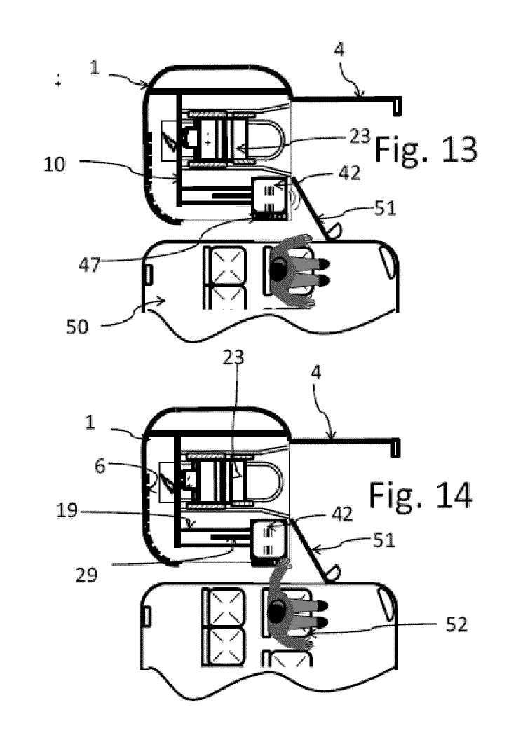

The device then causes the forward movement of the jump seat 20, with its carriage 25 on its rails 19, of the sensor means supported by the jump seat 20 and/or the box causing it to stop 25 cm away from the open door 51 of the vehicle 50 (FIG. 13). In this forward position, the jump seat 20 is substantially next to the seat 52.

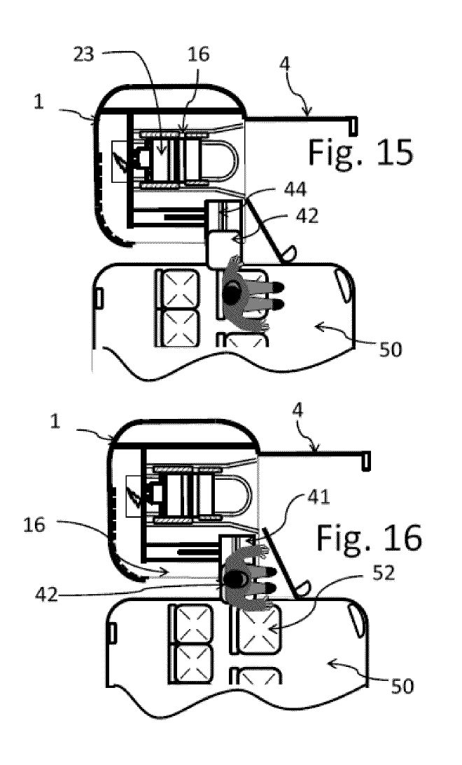

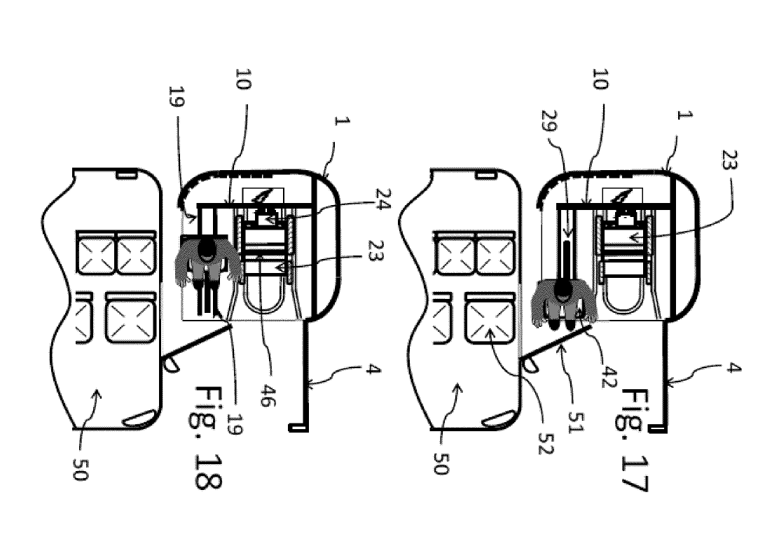

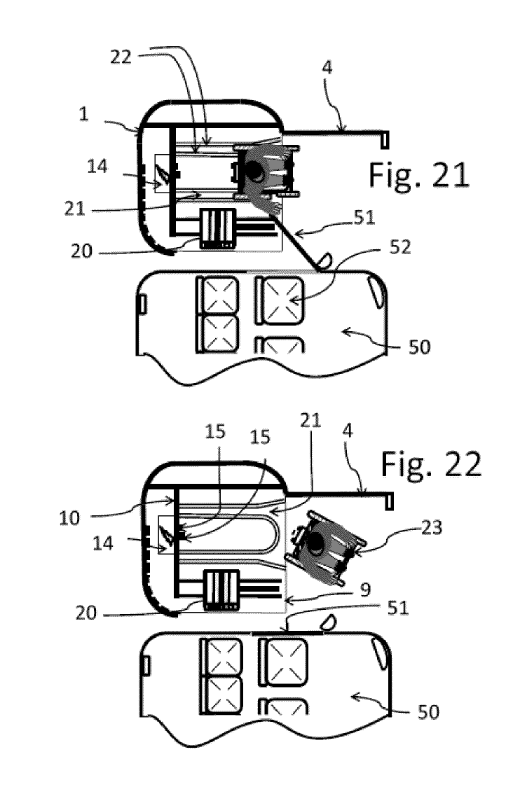

The user can then actuate the control means 47 of the laterally movable carriage 34 (FIG. 14) and slide the latter, with its upper tray 41, into the immediate vicinity of his seat 52. He can then, if necessary, actuate the means for moving the height of the tray, such as the jacks 39 for bringing the tray 41 to the necessary level relative to his seat. Next, he manually pulls the seat bottom 42 toward him (FIG. 15), then moves himself onto the seat bottom (FIG. 16). By pressing with his left hand on the opposite edge of the jump seat, he brings the seat bottom 42, which supports him, into its initial position on the tray 41 of the carriage 34, which also frees access to the control panel 47, then actuate the control means 47 to return the laterally movable carriage 34, with its tray 41, completely onto the carriage 25 of the jump seat (FIG. 17), after which, if applicable, the jacks 39 are actuated to return the seat bottom to its normal vertical level, which will allow the transfer onto the wheelchair. By acting on the controls, he then causes the jump seat to move backward on its rails 19, to the transfer location, as shown in FIG. 18. In this location, the lateral guide rails 44 of the jump seat 46 and of the wheelchair 23 are aligned, and the user transfers himself manually, on his seat bottom 42, toward the wheelchair (FIG. 19), bearing on the left armrest of the wheelchair, after, if necessary, having raised the right armrest. Once he is positioned on the seat bottom of the wheelchair (FIG. 20), he can actuate the control means of the wheelchair, which can be freed from the connecting means 15, and locking means (not shown) of the wheelchair preferably provided, move forward (FIG. 21) and move toward the exit, away from the end of the open door of the motor vehicle (FIG. 22). Once the personal vehicle has left its position, the seat bottom is locked on the personal vehicle.

Once out of the ruts 21, he can manually close his car door and, optionally, cause closing of the doors 4 and 6, preferably on the condition that the detector confirms the closure of the car door, then leave the premises.

When he returns, he can open the doors 4 and 6. He will then position himself, in reverse, while being guided in the ruts 21, up to the transfer position shown in FIG. 20, in which the wheelchair 23 is immobilized and the electrical recharge connection is reestablished by the connections 15, which will also cause the release of the blocking means, for example of the click type. He will next perform the reverse transfer steps onto the jump seat 20, while still being seated on the seat bottom 42, then advance on the seat bottom toward the car door. Using the control panel 47, he stops the jump seat, in an intermediate position, to manually open the door of the motor vehicle, then continue his forward motion until stopping 20 cm away from the car door, still under the control of the remote ultrasound sensor. He next causes the carriage 34 to exit, optionally commands a height variation of the seat bottom 42, then, still seated on the seat bottom, he slides into the immediate vicinity of his seat, onto which he transfers himself by his own strength. Next, after having manually pushed the seat bottom 42 back toward the jump seat and then once again having access to the control panel 47, he causes the carriage 34 with its tray 41 to go back in, then the reverse return of the carriage 25 of the jump seat. He can then close his car door and close the doors 4 and 6 of the box, then leave the premises.

In the embodiment described above, the movement direction of the jump seat is substantially parallel to the axis of the device, and the axis of the motor vehicle. It will, however, be understood that this direction, i.e., of the rails 19, can be slightly inclined toward the front end side of the motor vehicle, such that, in its forward position, the jump seat is still close to the seat 52.

Reference will now be made to FIGS. 24 to 33.

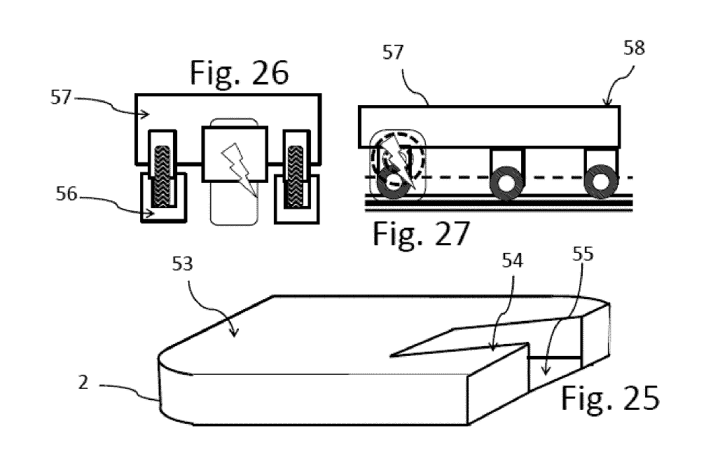

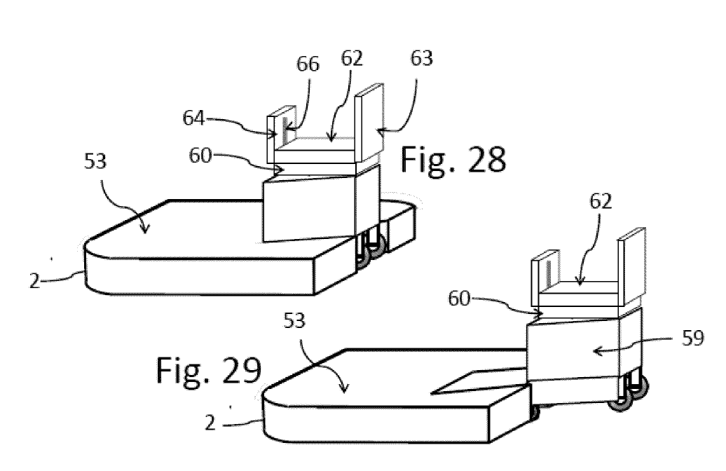

In this other embodiment of the invention, the device has the box 1 with its base 2, leaving a hollow space of approximately 25 to 30 cm inside. The lateral side 8 of the box can optionally be extended by a wall. As shown in FIG. 25, the upper wall 53 of the base, which forms the bottom on which the wheelchair will roll, has, on the side of the wall 5, a trapezoidal indentation 54 oriented obliquely. The lower base wall 55 has two rails 56, arranged obliquely from the rear corner of the box and extending below the indentation. Guided and maintained by these rails, owing to a plurality of feet and wheels, is a movable jump seat carriage 57, with a trapezoidal shape, which, in the retracted position (FIG. 28), retracts below the base wall 53, while having its front end 58 visible in the indentation 54. The base also houses means for driving the carriage (not shown), for example of the worm screw type, with an electric motor.

In reference to FIGS. 28 to 33, one can see that the moving carriage 57 bears, on its part 58, which remains visible in the indentation when the carriage is in the position withdrawn in the base, a structure 59, forming the jump seat strictly speaking. This structure 59 for example has a box shape supporting, in its upper part, a stationary central tray 60 bearing a horizontal rail or guide 61 allowing the sliding of a moving seat bottom 62. As can be seen in particular in FIG. 31, the direction of the rail, and therefore the movement of the seat bottom, is inclined by an angle of 60° relative to the longitudinal axis of the device, which itself is parallel to the longitudinal axis of the motor vehicle. For the convenience of the drawing, we have not shown the slider, which is guided in the rail 61 and which bears the seat bottom 62, but it will be understood that this rail and this slider can be similar to the rail 44 and the slider 43.

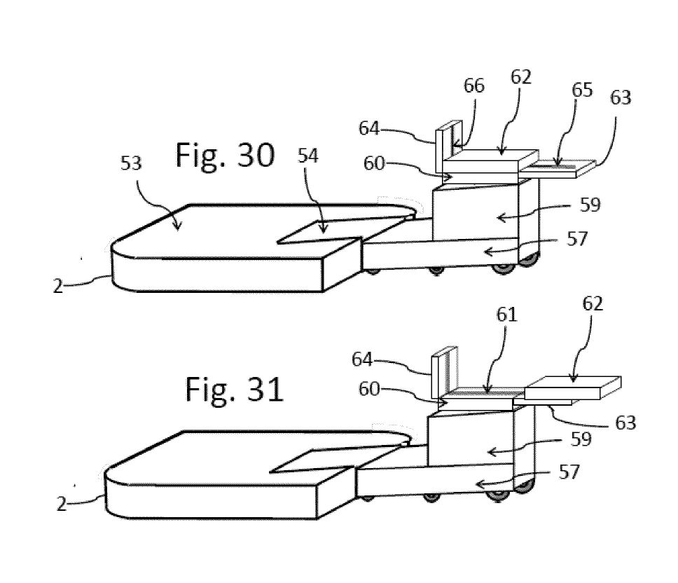

As shown in FIGS. 30 and 31, the jump seat carriage 57 can leave the base 2 in large part and roll on the ground, while remaining obliquely aligned with the rails 56, and a rack (not shown) similar to the rack 29, and cooperating with a toothed wheel motor (not shown) similar to the motor 28. To that end, the carriage 57 can bear a rear extension (not shown), with rollers or wheels remaining in the rails 56.

On the two lateral sides of the stationary tray 60, two pivoting trays 63 and 64 are hinged each bearing a rail or guide 65, 66 with the same section as the rail 61, which, when the corresponding pivoting tray is brought into the horizontal position, extends the rail 61 of the central tray, thus allowing the user to slide the seat bottom 62 on that of the pivoting trays 63, 64 that has been pivoted in the horizontal position. Stops (not shown) prevent the seat bottom from sliding outside the pivoting trays. Lastly, lifting means (not shown), such as jacks similar to those of FIGS. 4 to 10 and their control means, are positioned in the structure 59 to modify, if necessary, the vertical position of the tray 60, and therefore the height of the seat bottom 62, the latter being found, when these means are not actuated, at the level allowing the transfer of the seat bottom between the wheelchair and the jump seat. A control panel, not shown, may be present at the jump seat to allow the user to control its horizontal and vertical movements.

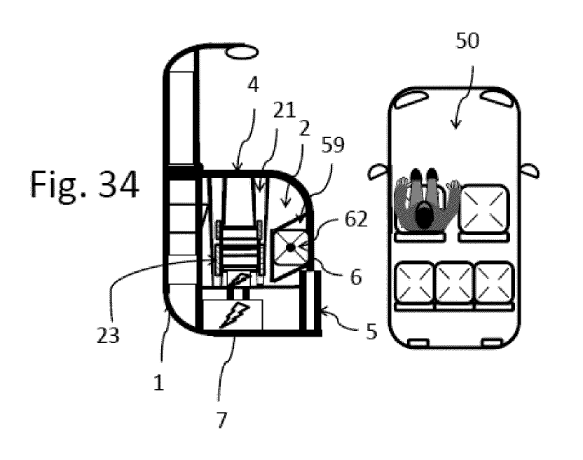

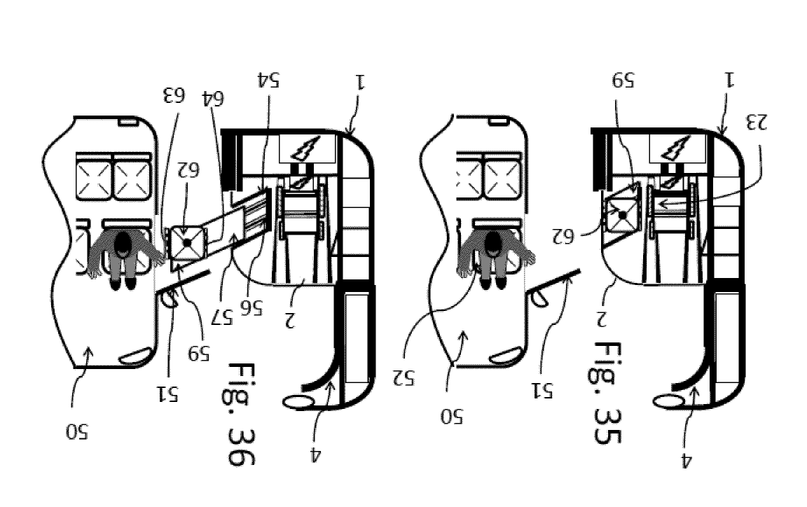

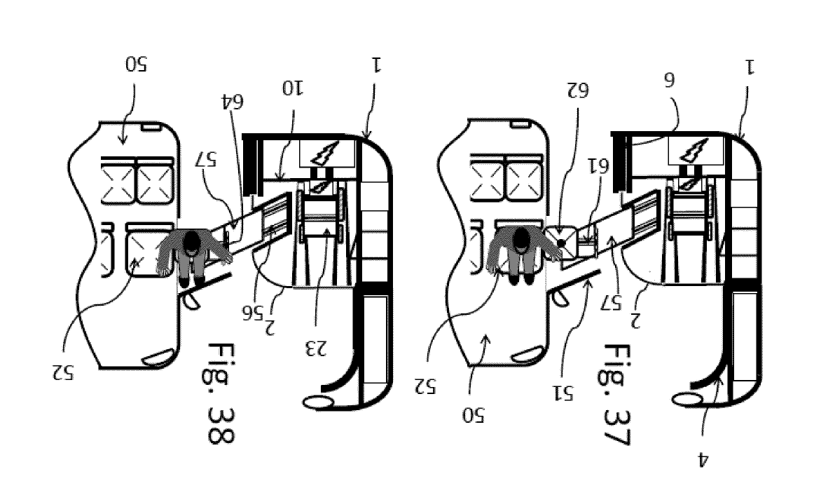

FIG. 34 shows the inside of the furniture or box, similar to that of FIG. 2, with a pivoting swinging door 4 and a retractable door 6, as well as inner partitions defining similar spaces, the rear space containing the power source 14, to which an electric motorized wheelchair 23 is connected, immobilized in its transfer location, in ruts 21 of the upper wall 53 of the base 2 and widening toward the front. One can see that the jump seat 59, with its seat bottom 62, is in the withdrawn transfer position, substantially next to the wheelchair 23, in the position also shown in FIG. 28.

Reference will now be made to FIGS. 34 to 42.

The user stops his motor vehicle 50 (FIG. 34) at a distance of approximately 1 m from the side 5 of the box, optionally using ruts (not shown) fastened on the ground of the parking lot. His axial position can be determined, for example by a marking, or by a detector, for example a means for detecting the exact position of the door 51 of the motor vehicle that is still closed, for example by detecting the interstice behind the rear edge of the closed door. In this case, it is preferable for the device to include a visual means, for example a screen or light signal, or audio signal, allowing the user to park the motor vehicle in an accurate axial position relative to the device according to the invention, corresponding to a precise position determined in advance for said interstice. The user then causes the doors 4, 6 to open by actuating a remote control means.

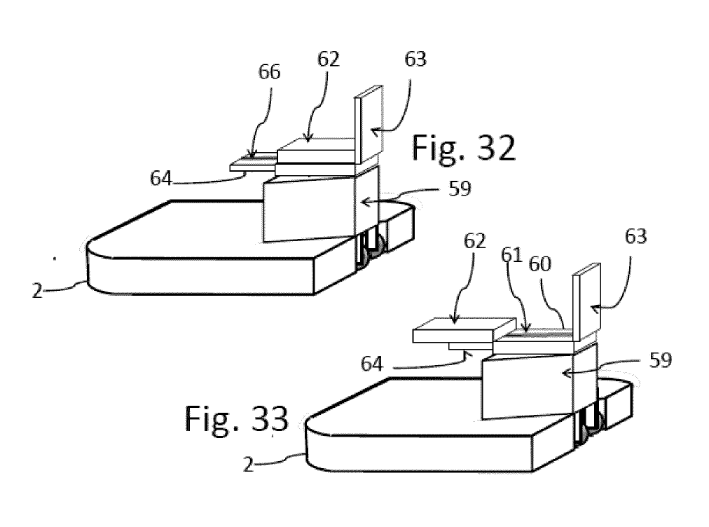

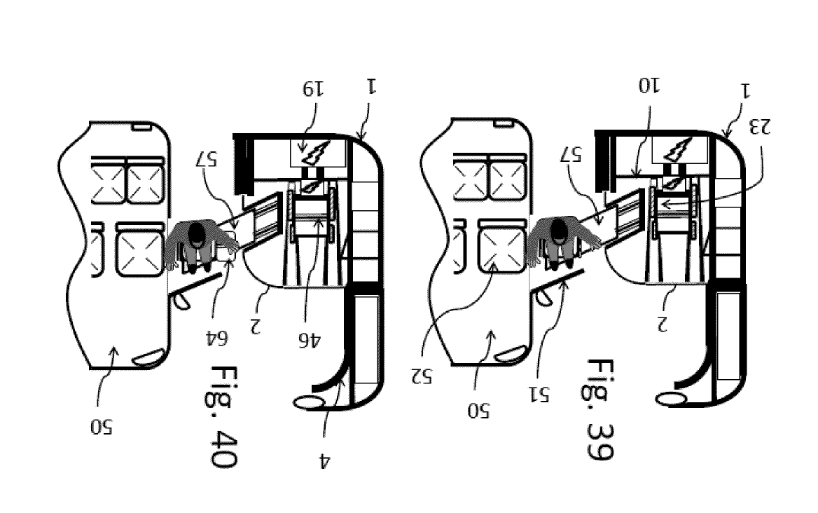

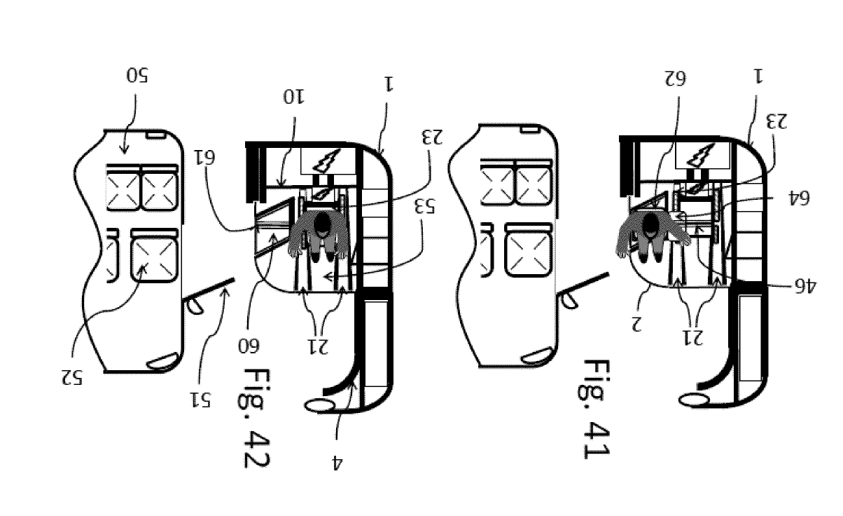

The user then opens his car door 51 (FIG. 35), then causes the jump seat 59 to advance on an angle, the movable carriage of which partially leaves the base, the front wheels of the carriage then rolling on the ground, up to the position of FIG. 36, the stop for example being caused by the detection of the motor vehicle by an ultrasound sensor, 30 cm away from the seat, for example. The jump seat is then in the state shown in FIG. 29. After having commanded, if applicable, a modification of the vertical height of the jump seat 62, he can then pivot the pivoting tray 63 downward (FIG. 30), then pull the seat bottom 62 toward him, in the immediate vicinity of the seat 52 of the motor vehicle (FIGS. 31 and 37). He then transfers himself by his own strength onto the seat bottom 62 (FIG. 38), which he then slides onto the tray 60, after which he folds the moving tray 63 upward (FIG. 39). He next folds the other pivoting tray 64 (FIG. 40). He next commands the return of the carriage 57 of the jump seat, which stops in the transfer location, the pivoting tray 64 becoming positioned in the immediate vicinity of the wheelchair, aligned with the rails 46, 66 and 61 for guiding the seat bottom (FIGS. 41 and 32). He can then transfer himself, on his seat bottom 62, to the wheelchair 23 (FIGS. 42 and 33), then tilt the tray 64 upward. By actuating the driving and steering commands of the wheelchair, he can go forward and free himself from the ruts 21. From there, he will be able to steer himself toward the motor vehicle and close the car door 51. If he wishes to move directly toward the rear of his car, for example toward the trunk or to get gas, the passage between the box and the motor vehicle is sufficient.

When he returns, he will cause opening of the doors 4 and 6, then manually open the door 51 of his car. He will next position himself, in reverse, being guided in the ruts 67 to the transfer position shown in FIG. 34 in which the wheelchair is immobilized and the electric connection for recharging is reestablished. He will next perform the reverse steps for transferring onto the jump seat 59 while still being seated on the seat bottom 62, then forward motion of the jump seat toward the car door, until stopping 20 cm from the car door, still under the control of the remote ultrasound sensor. He then tilts the tray 63, optionally after varying the height of the seat bottom, then slides the seat bottom 62 into the immediate vicinity of his seat, onto which he will transfer himself by his own strength. Next, after having manually pushed the seat bottom back toward the jump seat and raised the tray 63, he causes the jump seat to return in reverse. He can then close his car door and close the doors 4 and 6 of the box, then leave the premises.

The wheelchair preferably includes standard jump armrests (not shown) that prevent him from rolling, when they are not folded in, in particular during transfers between the wheelchair and the jump seat. The jump seat optionally includes armrests that are also retractable. If it bears pivoting trays 63, 64, these trays can also play this role. Lastly, the jump seat can include a backrest (not shown) limiting the possibility of backward movement by the user seated on the jump seat.

In all of the described examples, the device includes a movable seat bottom transferable between the jump seat and the wheelchair and serving as the seat bottom for the movement on the jump seat, then as wheelchair or scooter seat bottom. However, in one non-preferred embodiment, it is possible to implement a personal vehicle provided with its own seat bottom, the user then having to go from the jump seat to the wheelchair, and vice versa, through his muscular force alone.

The temporary electrical connecting means 15 between the box and personal vehicle, such as the wheelchair, are within the immediate reach of one skilled in the art. Preferably, the wall 10 can have one or two short arms extending horizontally from the wall 10 toward part of the wheelchair, and bearing electric contacts respectively connected to the terminals of the battery 24. It is then possible to provide, at the rear part of the wheelchair or personal vehicle, for example provided with a rear vertical plate, corresponding contacts connected to the battery 24, and which press elastically against the contacts supported by said arms when the vehicle, centered by the ruts 21, has reached its rear position against the wall 10.

Preferably, fasting means of any type are provided to immobilize the vehicle in this position, the fastening means being releasable by the user seated in the personal vehicle.

In summary, the different phases of the operating method of the device according to the described example include the following steps.

Initial opening phase:

taking into account the arrival of an authorized vehicle, for example by remote control, for example of the NFC (Near Field Contact), QR code or barcode type, or other authentication systems,

opening the entry gate, if the parking area for the motor vehicle has one,

preferably, verifying the correct positioning of the motor vehicle,

preferably, verifying that the car door of the motor vehicle is not open, this step optionally being able to be omitted if obstacles are provided on the ground preventing the motor vehicle from parking too close to the lateral side 5 of the box,

accounting for the request to open the device, for example by remote control, or by remote operator,

optionally, verifying the absence on the surface in front of the box door(s),

opening the box,

verifying the open position of the motor vehicle door,

moving the jump seat forward while continuously verifying the lack of obstacles in front of the door and detecting the position of the open car door; if the device includes a structure moving both the jump seat and the personal vehicle, forward motion of said structure up to the transfer locations,

stopping the jump seat in the forward position corresponding to the forward position next to the seat of the motor vehicle,

if applicable, vertically moving the seat bottom to the level of the motor vehicle seat,

preferably, detecting the lateral offset movement of the seat bottom relative to the jump seat,

detecting the presence of the user on the seat bottom,

detecting the return of the seat bottom into position on the jump seat,

withdrawing the jump seat toward its transfer location next to the personal vehicle, if its forward position is in front of the transfer position,

detecting the arrival of the seat bottom on the personal vehicle,

detecting the release of the personal vehicle, and its removal from the box,

optionally, detecting the closed position of the car door, the lack of obstacles in front of the door(s) or closure(s) of the box, and intermediate closing of the box, controlled by the user.

Reopening phase, in case of intermediate closing:

preferably, verifying the correct positioning of the motor vehicle,

preferably, verifying the absence of open position of the motor vehicle door,

accounting for the request to open the device, for example by remote control, or by remote operator,

optionally, verifying the absence on the surface in front of the box door(s),

opening the box,

verifying the open position of the motor vehicle door,

Return phase in the motor vehicle:

return of the personal vehicle in reverse, to the transfer location,

immobilization of the personal vehicle, and electrical connection to recharge its battery,

transfer of the seat bottom supporting the user to the jump seat,

detection of the seat bottom and the user on the jump seat,

forward movement of the jump seat controlled by the user, with continuous verification of the absence of obstacles in front of the door and detection of the position of the open car door, if its forward position is in front of the transfer position,

stopping the jump seat in the forward position corresponding to the forward position next to the seat of the motor vehicle,

if applicable, vertically moving the seat bottom to the level of the motor vehicle seat,

preferably, detecting the lateral offset movement, toward the seat, of the seat bottom relative to the jump seat,

detecting the absence of the user on the seat bottom,

detecting the return of the seat bottom into the idle position on the jump seat,

optionally, vertical movement of the seat bottom,

moving the jump seat backward, then stopping the jump seat in its position removed from the box; if the device includes a structure moving both the jump seat and the personal vehicle, backward return of said structure to the locations removed from the box.

Final closing phase:

taking the closing request into account,

verifying the presence of the personal vehicle or wheelchair locked in its transfer location, and that of the jump seat in the withdrawn position,

verifying the absence of the user on the seat bottom,

preferably, verifying the proper positioning of the seat bottom on the jump seat,

preferably, verifying the absence of open position of the motor vehicle door,

closing the box,

releasing the exit gate, if one is present,

verifying the departure of the vehicle.

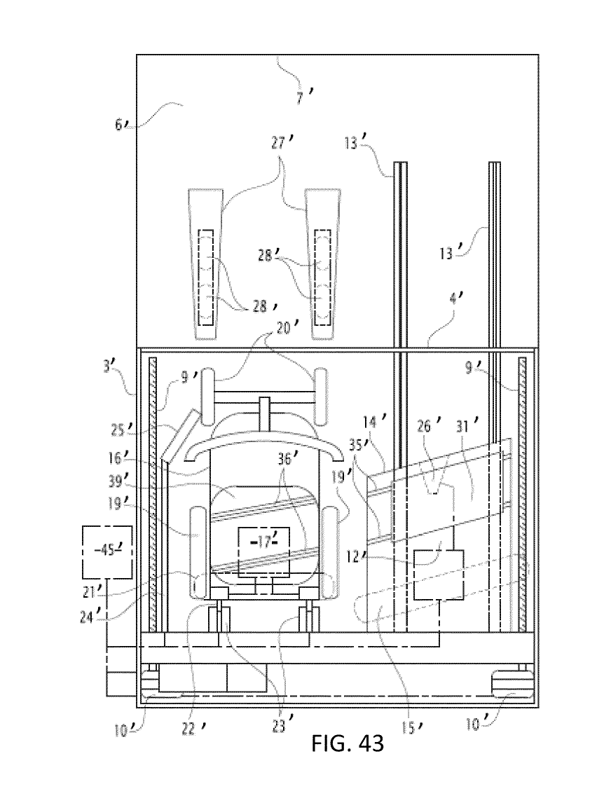

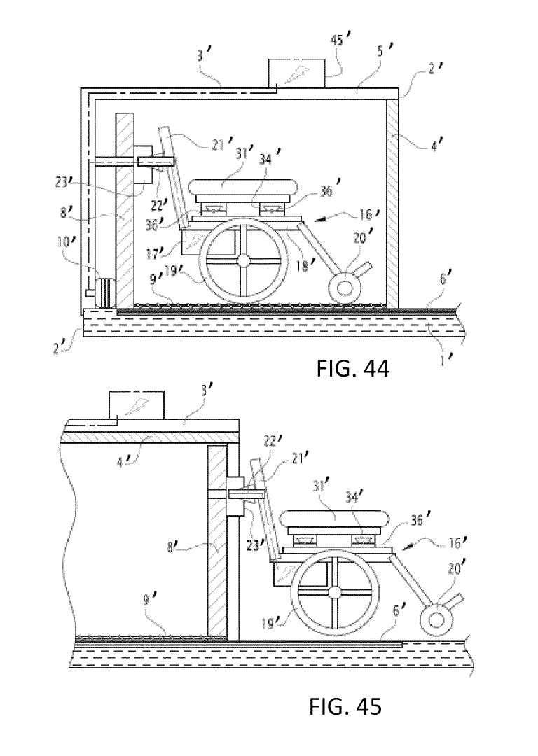

Reference will now be made to FIGS. 43 to 45.

In this other embodiment, the device according to the invention has a base 1′, for example made from reinforced concrete, bearing a box 3′ provided with a swinging door 4′ that can retract below the upper part 5′ of the box. The base 1′ continues, in the forward direction, by a surface or area 6′ ending with an edge, preferably beveled to facilitate the rolling of the wheelchair between the base 1′ and the ground on which it rests. A movable structure 8′, having a vertical wall form, and situated, when idle, toward the bottom of the box 3′, can be translated in the box 3′, until entering the box, for example using two worm screws 9′ that can be driven in both directions by an electric motor 10′.

The dimensions of the different parts of the device are for example as follows:

base length: from 3 to 4.5 m, for example 3.5 m.

base width: from 1.15 to 1.6 m, for example 1.25 m.

base length: from 1.10 to 1.6 m, for example 1.25 m.

box height: from 1.10 to 1.50 m, for example 1.25 m.

length of the surface after the box: from 0.8 to 1.40 m, for example 0.95 m.

width of said surface: from 1.05 to 1.40 m, for example 1.25 m.

maximum height of the poles: 2 m.

Consequently, it is possible to place these devices in any desired location, for example in outdoor or underground parking areas, in shopping mall or hospital parking lots, etc.

On the front of the wall of the structure 8′, and on its right side, a jump seat 12′ is fixed. Preferably, this jump seat 12′ has a base downwardly having for feet mounted on casters, but it is also possible to provide for the jump seat to be supported, cantilevered, by the wall 8′, if the latter is strong enough. It is possible to provide that the casters of the jump seat can be guided by rails or guideways 13′ fixed on or in the base 1′ and extending onto the surface 6′ such that the jump seat is guided between its position inside the box and it is predetermined location on the surface 6′. Preferably, these guideways have a section preventing removal from above. This guiding of the jump seat can also facilitate proper guiding of the wall 8′.

As shown in FIGS. 43 and 46 to 55, the front vertical wall 14′ of the jump seat is inclined relative to the wall of the sliding structure 8′. The jump seat has a backrest 15′ also inclined relative to the plane of the wall 8′. Furthermore, the jump seat does not have armrests. If the seat bottom is provided with armrests, they must be able to be raised.

In the box 3′ and to the left of the jump seat 12′, is a wheelchair 16′, preferably motorized, for example using an electric motor with a battery 17′, and provided with its own steering and braking means. The armrests of the wheelchair 16′ are articulated to be able to be raised and lowered, as is standard. The wheelchair includes a chassis 18′ with large rear driving wheels 19′ and small front steering wheels 20′ with a backrest 21′.

The backrest 21′ of the wheelchair has short extensions or arms 2′ allowing releasable fastening to the fastening means 23′, secured to the movable wall 8′, and comprising securing means, for example jaws, capable of grasping the arms 22′ and freeing them. Preferably, this fastening of the arms 22′ of the wheelchair also causes the triggering of the electric connectors, allowing charging of the battery 17′ of the wheelchair. It is advantageously possible to provide guide means for proper entry of the arms 22′ into the securing means 23′, for example in the form of funnels guiding and centering the arms 22′ during their backward return.

From the wall 8′, and parallel to the wheelchair, an arm 24′ extends that bears a screen-keyboard assembly 25′, accessible to the user once the latter is seated on the wheelchair.

The jump seat 1′ has, at its front wall 14′, a proximity detector 26′, of a type commonly used in motor vehicles for parking assistance. This detector 26′ is functionally connected to control means of the motors 10′ to cause them to stop 25 cm away from any detected obstacle. It is in particular oriented to detect the open car door of the user's motor vehicle, and to stop at this distance from the car door.

The base 1′ has, in the surface 6′, two guide ruts 27′, flared toward the front to receive and guide at least the rear driving wheels 19′ of the wheelchair when the latter leaves the box under the thrust from the wall 8′, as well as when the user returns backward to bring the wheelchair back to the position in which the gripping means 23′ will be able to grasp the arms 22′ and reestablish the electrical connection between the wheelchair and the power circuit of the wheelchair battery 17′.

It is possible to provide, for example in a location of the ruts 27′, pairs of rollers 28′, on which the rear wheels 19′ rest when the wheelchair 16′ is in its forward location, when it leaves the box, with lifting means, for example horizontal plates that can be raised by electric jacks to lift the rear wheels, unstick them from the rollers 28′ and allow the wheelchair to move forward. When the rear wheels 19′ rest on the respective pairs of rollers 28′, the user seated on the wheelchair can familiarize himself with the standard rolling commands of the wheelchair. To that end, it is possible to provide a simulation program, of the electronic game type, responding to the control means of the wheelchair, levers or other means, allowing the user to undergo simulated training on how to drive the wheelchair.

In one embodiment, the travel of the wall 8′ is always identical, except in case of an earlier stop if the detector 26′ has detected an obstacle. In this embodiment, the motor vehicle must position itself very precisely, so that the seat of the motor vehicle is situated next to the jump seat. It is an preferable to equip the device according to the invention with a detector, of a known type, that precisely detects the position of the slot that is present, just behind the rear edge of the closed car door of the motor vehicle, this detector informing signaling means, for example a signaling light, indicating to the user or driver that he has reached the proper position.

If the device has both sets of driving rollers 28′, it is then possible to provide that the wheelchair 1′ automatically positions itself on the rollers 28′ at the end of travel of the movable structure wall 8′. This position on the rollers then constitutes the transfer location of the wheelchair, and therefore also determines the transfer location of the jump seat, and the forward position thereof.

In another embodiment, the travel of the wall 8′, instead of being fixed, is automatically determined by the detection of the open car door of the motor vehicle. Preferably, the jump seat 12′ and the wheelchair 16′ do not have their own seat bottoms. The movable seat bottom 31′ has a parallelepiped shape, two sides of which are parallel to the movement axes of the vehicle, the jump seat and the motor vehicle, and therefore the outer edge of the seat 32′ of the motor vehicle, the other two sides being inclined by an angle comprised between approximately 55 and 65°, for example approximately 60°, to be more or less parallel to the car door 33′ of the motor vehicle, in the open state. The seat bottom 31′, the upper surface of which can have a comfort padding, like a seat, has, at its lower surface, two sliders parallel to the front and rear edges of the seat bottom, allowing the seat bottom to slide easily on the guideways, with a section for example in the shape of a dovetail preventing lifting of the seat bottom 31′. More specifically, the jump seat 12′ and the seat 16′ respectively receive two pairs of guideways 35′, 36′ that can receive the seat bottom 3′ and allow it to slide.

When the wheelchair 16′ and the jump seat 1′ are in their respective transfer locations, the guideways 35′, 36′ of the two pairs are aligned, as shown in FIGS. 43 and 47 to 51, which allows the user, by moving the seat, on which he is seated, to transfer the seat bottom from the jump seat to the wheelchair and vice versa. The length of the sliders secured to the seat bottom is such that the partial cantilever produced when the seat bottom crosses the space that separates the respective guideways 35, 36 does not prevent the seat bottom from staying in its horizontal position perfectly aligned with the guideways. Preferably, the ends of the guideways and/or sliders are beveled so that the ends of the guideways easily accommodate the sliders during the passage from the jump seat to the wheelchair and vice versa.

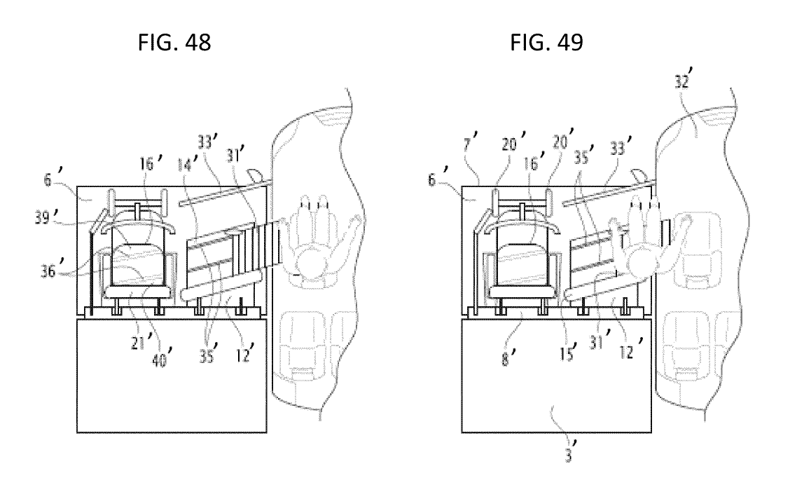

Furthermore, the seat bottom 31′ can shift partially toward the seat of the motor vehicle, as seen in FIGS. 48 and 49, which facilitates the transfer of the user between the seat and the jump seat, a stop supported by the jump seat limiting the amplitude of the offset. Another stop supported by the wheelchair determines the final position of the seat bottom 31′ on the wheelchair. Lastly, a stop means (not shown) supported or actuated by the right armrest 19′ of the wheelchair blocks seat bottom 31′ on the wheelchair and prevents any movement toward the jump seat when the armrest 19′ is lowered.

In order to offer the user a completely normal seat bottom with a straight front edge, the wheelchair has, on its front side, a triangular lift element 39, the upper face of which is in the same horizontal plane as the upper face of the seat bottom 31′, the inclined front edge being positioned practically against the rear edge of the lift 39′. The wheelchair does not have a lift on its rear side, and the rear inclined edge of the seat bottom is simply housed in the space left free between the horizontal surface of the wheelchair that supports its guideways 36′ and the lower edge of the backrest 21′ of the wheelchair.

The device shown in the Figures can also include different power supply, computerized management and communication means with a control center situated elsewhere and/or the vehicle and/or the user, these means preferably being situated on or in the box 3. These means, the acquisition and implementation of which are readily available to one skilled in the art, can comprise:

a battery 45′ associated with an inverter directly connectable to a power outlet of the sector of the location, parking lot or premises, where the device is installed, this battery preferably powering all of the electrical and computer devices of the device. The travel of the electrical conductors served by the battery 45′, as well as the battery 17′ of the wheelchair 16′, and the motors 10′ of the drive means of the structure, such as the screws 9′, are shown very diagrammatically in mixed lines,

a motor (not shown) for actuating the door or closure 4 of the box 3,

if applicable, a mechanism for actuating the device for lowering and raising the wheels of the personal vehicle relative to the rollers 28′,

the battery 17′ of the vehicle, by means of separable connectors at the jaws or fastening means 23′,

preferably, a detector for detecting a presence on the surface before opening the door 4′, for example an infrared sensor, for example available from the companies BALUFF or MICROSONIC (German origin) or EXTRONIC (SWEDISH origin),

means for detecting the fixed or released state of the personal vehicle with respect to the wall 8′, for example by simple electrical contacts associated with retaining clicks and release of the rear arms of the wheelchair, and preferably identification means of the personal vehicle, or even of the user, for example using a remote card reading system, for example by the company BALUFF and MICROSONIC (German origin) or EXTRONIC (Swedish origin),

preferably, a camera allowing an operator situated remotely to view the device and the motor vehicle, and/or a microphone-speaker system to communicate with the user,

one or more gate actuating motors for one or more gates in front of and/or behind the motor vehicle parked next to the surface 6 and/or signal lights,

the gate radar or detector 26′, and preferably another obstacle detector presented at the vehicle level, preferably ultrasound detectors, for example available from the companies BALUFF or MICROSONIC (German origin) or EXTRONIC (SWEDISH origin),

preferably, means for detecting the position of the seat bottom, in particular its position on the jump seat and its position on the wheelchair or personal vehicle, for example by electric contacts sensitive to the passage of the seat bottom,

optionally, means for blocking the seat bottom on the jump seat and/or on the vehicle,

means for detecting the presence or absence of the driver on the seat bottom, for example a sensor sensitive to the weight of the seat bottom, or an electric contact actuated by a vertical movement or a deformation of the seat bottom, for example of the type used for motor vehicle seats,

preferably, computer means for processing signals received by the various sensors or detectors and implementing different delivery and return phases of personal vehicle.

The device also includes an automatic entry gate 41′, positioned laterally at the edge of the front end of the box 3′, and optionally an exit gate positioned slightly past the rear base or rear surface edge, these gates being able to be completed by signal lights.

Initially, the gates are closed and the wall 8′ of the movable structure is in its rear position keeping the jump seat 12′, which bears the seat bottom 31′, and the wheelchair 16′ contained in the box 3′, the door 4′ of which is closed.

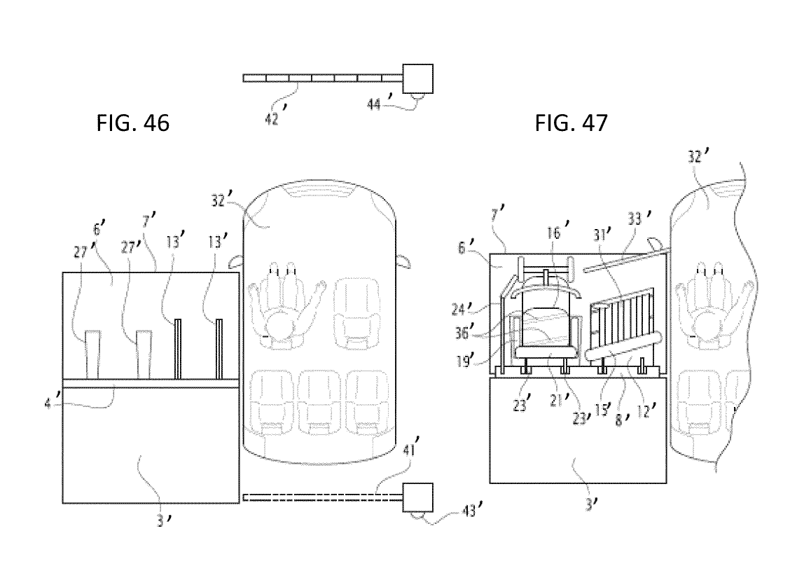

The car 32′ of the disabled driver using the invention presents itself in front of the entry gate 41′ and actuates remote control means causing opening of the gate, which allows the personal vehicle 32′ to roll into the position shown in FIG. 46, in which the articulation of the car door 33′ is where the area 6′ extends in front of the closure 4′ of the box.

Preferably, the gate then stays open to allow the user to leave again in reverse.

The user then opens his car door 33′.

The user next actuates his remote control, which then causes opening of the box door 4′, the gradual forward movement of the wall 8′, driven by the worm screw motor means 9′, this movement being interrupted if the radar detector 26′, in front of the jump seat, detects an obstacle on the surface 6′. When this detector detects the open car door 33′, it causes the immobilization of the wall 8′ when it is 25 cm away from the car door.

In this position, shown in FIG. 47, the jump seat 12′ is in a position accessible to the user, who needs only extend his arm to grasp the seat bottom 31′ and pull it toward him, until it is next to his seat (FIG. 48). Next, the user moves laterally on his seat, under the seat bottom 31′ (FIG. 49), then pushes the latter back on the jump seat.

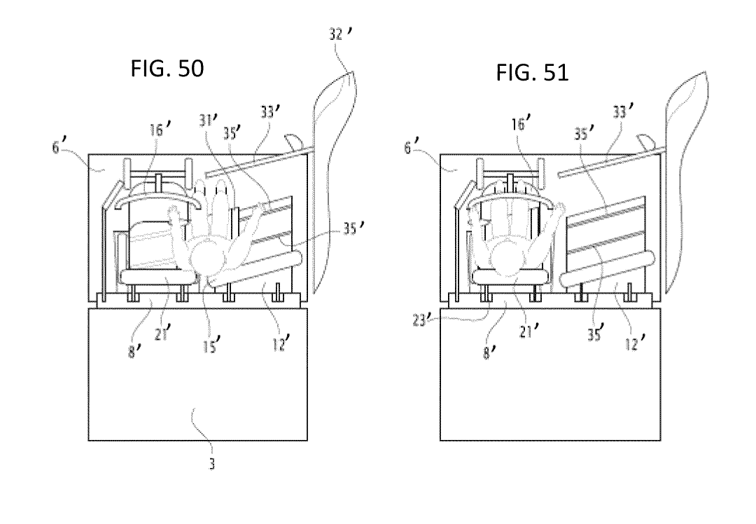

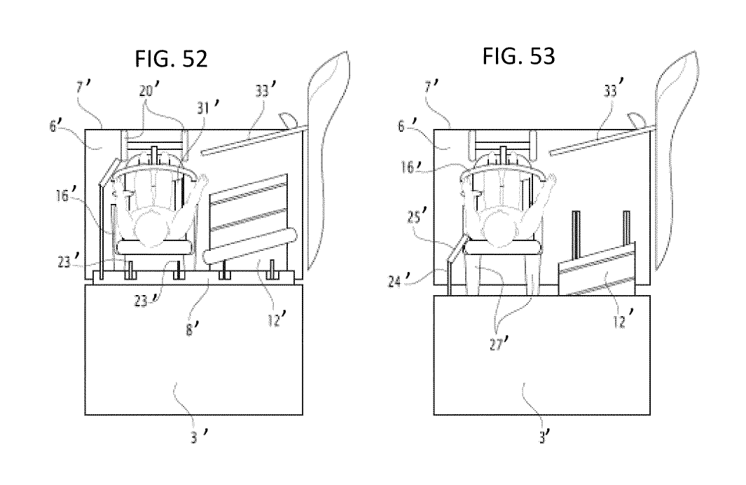

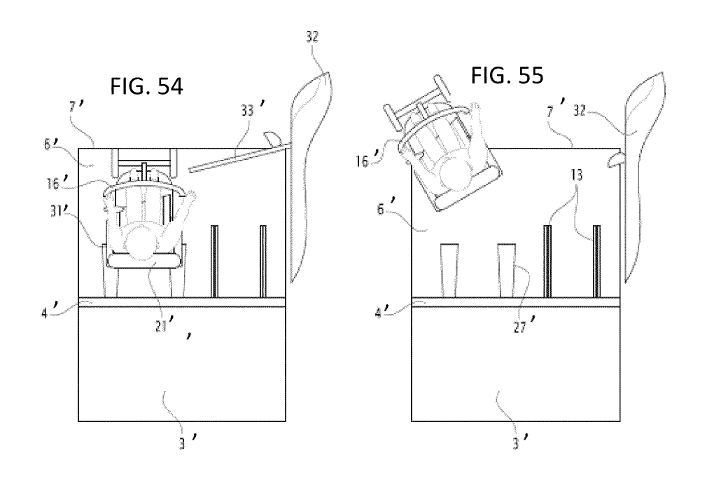

The user then raises the right armrest (not shown) of the wheelchair 16′, on which he can then laterally transfer himself by sliding his seat bottom (FIG. 50) onto the wheelchair (FIG. 51). After lowering the armrest of the wheelchair, he then actuates unlocking means releasing the wheelchair from the locking means 23′, for example by means of a lever separating the gripping jaws of the arms 22′, which releases the wheelchair, which he can then drive forward (FIG. 52), until he is free from the ruts 27′, then command the withdrawal of the structure 8′ and the jump seat 12′ into the box (FIGS. 53 and 54). He can maneuver the wheelchair onto the area 6′ and close the car door (FIG. 55).

He can then steer himself forward and leave the area 6′ by its front edge 7′, then travel freely. He can also access the other side of his motor vehicle, and maneuver the car doors and the trunk.

When the user returns in his personal vehicle 16′, the preceding steps are carried out in the opposite order.

From his car, he remotely controls the withdrawal of the structure 8′, with its jump seat and wheelchair, and the closure of the box 3′, with the different associated automatic verifications.

In one alternative of this embodiment, in which the transfer locations of the vehicle and the jump seat are such that the jump seat is not next to the seat of the motor vehicle, but further back, the movable structure or wall 8′ has means or jaws for gripping similar to the means 23′ that secure the wheelchair to the structure, the guide rails 13′ of the jump seat extending forward to allow it, once freed from the wall 8′, to roll or slide forward, with its seat bottom, until it is next to the seat of the motor vehicle. The user then extends his arm backward to grasp the jump seat and pull it over to him in a forward position next to his seat, then to transfer himself, with any offset of the seat bottom, to next withdraw to the predetermined location next to the wheelchair, then transfer himself on his seat bottom, under the wheelchair.

Preferably, means that can be actuated by the user are then provided to release the jump seat from the movable wall or structure, then to fasten it thereto again, during the backward movement toward the transfer location. The jump seat can advantageously include jump seat armrests, raising of which immobilizes the jump seat in its rails.

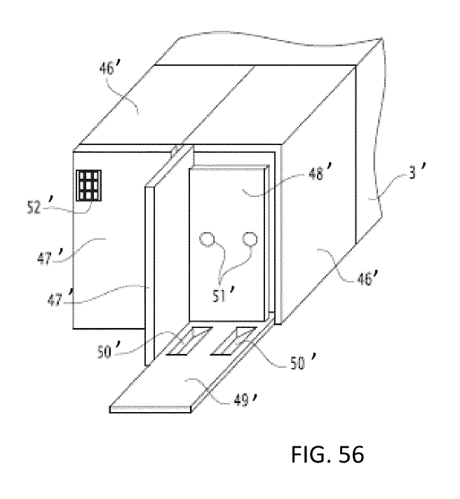

In reference to FIG. 56, another embodiment is shown in which the device also includes means for delivering two additional personal vehicles, for example scooters, to users capable of moving between their motor vehicle and the personal vehicle. The base 1′ is then extended toward the front of the box 3′ to support two boxes 46′ positioned side by side, and with a width equal to half that of the box 3′. Each box has a closure 47′, preferably in the form of a door with a single leaf. In each box 46′, a movable structure can move having a vertical wall 48′ able to slide between the bottom of its box and a forward position, in which it occupies the opening of the box, said structure preferably comprising a horizontal tray 49′ able to move on the base, preferably by worm screw driving similar to that of the box 3′, and having guide means for a scooter (not shown), for example centering ruts 50′ for the rear wheels of the scooter. The wall 48′ has two devices 5′ similar to the devices 23′, to receive fastening and electrical connection arms, similar to the arms 22′, positioned behind the scooter.

The user, who in this case is capable of moving on foot from his motor vehicle to the boxes 46′, causes the implementation of the device, for example using a digicode keyboard 52′ of the door 47′, causing opening of the door and the removal from the structure 48′, 49′. The latter includes a presence detector capable of blocking this movement in case of presence on its trajectory. When there is no detection, the structure arrives in its forward position shown in FIG. 56, and the user can sit on the scooter and leave the tray, the absence of the scooter being observed by the means 51′, and the absence of presence on the tray being observed by a sensor, for example sensitive to the weight of the tray. It is also possible to provide automatic withdrawal of the structure, or withdrawal controlled by the user.

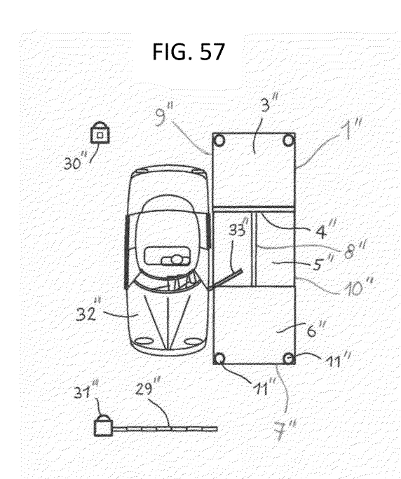

Reference will now be made to FIGS. 57 to 60.

In this embodiment, the device according to the invention has a base, for example made from reinforced concrete, supporting, at a forward end, a box 3″, of which it forms the bottom, this box being provided with a pivoting door 4″, opening on a central base part 5″ continuing, toward the other end, by a surface or area 6″ ending with an edge 7″, preferably beveled to facilitate the rolling of the wheelchair between the base 1″ and the ground on which it rests. An elongated hollow 8″ extends in the base, below the box 3″ and the central base part 5″, to receive a worm screw (not shown) that can be driven in both directions by an electric motor (not shown) situated at the bottom of the box, to advance or withdraw a sliding horizontal tray 12″. The latter can roll on two guide rails (not shown), parallel to the hollow 8″ and situated at a small distance from the two lateral edges 9″, 10″ of the rectangular base 1″. These rails extend in the box 3″ and over the central part 5″ of the base 1″.

The tray 12″ has, on the lateral side 9″, two hollow guide rails 15″ extending parallel to the side 9″, to receive and guide a rolling jump seat base. Parallel to these hollows, the tray 12″ has two guide hollows 17″, to guide the wheels of the wheelchair on the tray, these hollows emerging freely in the front edge 18″ of the tray.

The jump seat 19″ includes a base (not shown) downwardly having four feet (not shown) mounted on casters (not shown), the two right feet and the two left feet thus being able to roll while being guided, in the right and left rails 15″. These rails, however, prevent upward removal. The jump seat has a standard backrest, not shown, and two right and left armrests, also not shown and each able to be raised around a standard articulation, not shown, behind the armrests. When either of the two armrests is tilted in the raised position, to allow the lateral movement of the user toward the car seat or the wheelchair positioned on the side, this tilting drives braking means, not shown, such that the jump seat is then immobilized in its rails 15″. When the armrests are lowered, the casters can once again roll and the jump seat can move.

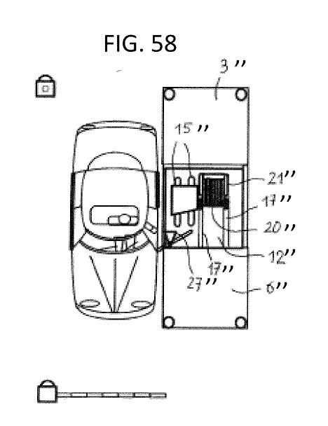

The wheelchair 20″ is a standard wheelchair, preferably motorized, and provided with its own steering and braking means. The armrests of the wheelchair 20″ are also articulated to be able to be raised and lowered, as is standard. When the wheelchair is situated in its predetermined waiting location, its rear wheels 21″ are situated at the rear end of the guide hollows 17″, the small front wheels also being received in the hollows 17″. Wheelchair immobilizing means (not shown), for example jaws able to grip the wheels 21″, automatically lock the wheelchair in its rear position (FIG. 58), control means, for example a lever (not shown), allowing the user to unlock it when he is seated on the wheelchair. Once the wheels 21″ are freed from the locking means, the user can actuate his wheelchair and roll forward to leave the tray 12″ and its ruts 17″ and roll onto the area 6″.

The tray 12″ bears, preferably at its front edge 18″, radar presence detectors, not shown, of a standard type, for example of the type mounted at the front and rear of motor vehicles for parking assistance. These detectors detect any potential obstacle in front of the tray and cause the tray to stop at a small distance from the obstacle, for example 20 cm.

Another radar detector, situated at the front of the tray, on the side 9″ where the vehicle parks, detects whether the car door of the motor vehicle is open, in the correct position, and in this case, limits the exit of the tray 12″ so that the tray is immobilized at a small distance from the open car door. For vehicles with sliding car doors, the tray 12″ will still advance until it is completely out, when no obstacle is detected.

The device can also include entry and/or exit gates, positioned laterally at the edge of the front end of the box 3″; one can see an exit gate 29″ positioned slightly past the rear base edge 7″, these gates being able to be completed by signal lights such as 31″.

Initially, the gates are closed and the tray 12″, bearing the jump seat and the wheelchair, is completely contained and enclosed in the box 3″, the door 4″ of which is closed.

The car 32″ of the disabled driver drives into the position shown in FIG. 57, in which the articulation of the car door 33″ is found where the area 6″ extends from the surface 5″.

The user then opens his car door 33″, this opening being detected by a radar or detection means borne by the box.

The user next actuates his remote control, which then causes the opening of the box door 4″, then the gradual exit of the tray 12″, this movement of the tray being interrupted if the weight sensor of the tray detects an excess weight, or if the radar detector, in front of the tray, detects an obstacle on the exit path of the tray, or if the detector observes that the car door 33″ is no longer in its completely open position.

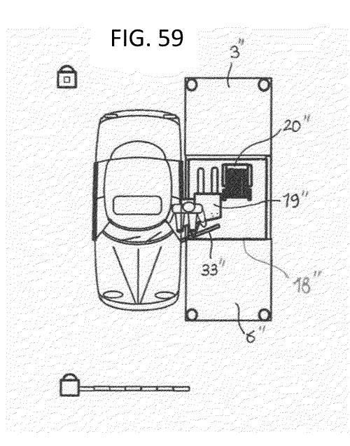

When the tray 12″ has stopped in the fully forward position (FIG. 58), the jump seat 19″ is in a position accessible for the user, who then needs only extend his arm backward to grasp the jump seat and pull it toward its forward position (FIG. 59). The user can then raise the right armrest of the jump seat, which immobilizes the latter in its forward position in the hollows 15″, and allows him to pull a movable horizontal plate (not shown) toward him that was retracted below the seat bottom of the jump seat. Alternatively, the seat bottom of the jump seat can be movable, as in FIG. 48, to be brought back into the immediate vicinity of the seat of the motor vehicle.

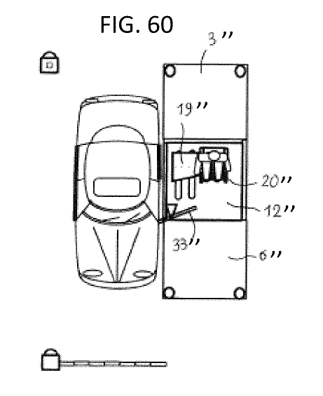

Next, the user moves his seat sideways, on the plate, then on the jump seat (FIG. 59), which allows him to slide the plate below the seat bottom in the jump seat, then to lower the armrest, which frees the jump seat, which the user then moves backward, transfer position in which he finds himself next to the immobilized wheelchair 20″ (FIG. 60).

The user then raises the left armrest of the jump seat 19″, which is then immobilized, then the right armrest of the wheelchair 20″, onto which he can then transfer himself laterally (FIG. 59). After having lowered the armrest of the wheelchair, he then actuates a jaw control means, which frees the wheelchair, which he can then drive forward, until he leaves the tray 12″ and is free of the slots 17″. He can maneuver the wheelchair onto the area 6″ and close the car door 33″.

From the area 6″, he can then actuate his remote control to return the tray 12″ into the box 3″ and close the door 4″, as long as no excess weight is detected on the tray 12″, or any animal or human presence in the box, and as long as the detector confirms the closing of the car door 33″ (FIG. 21). He can then move forward and leave the area 6″ by its front edge 7″, then travel freely. He can also access the other side of his car, and maneuver the car doors and the trunk.

If the user fails to actuate his remote control, the device has a machine that will return the tray if the above conditions are met. Otherwise, an alarm will actuate an intervention by a remote operator.

For the return, the user actuates his remote control, causing the door 4″ to open and the moving structure to exit made up of the tray, with the verifications cited above, then, on the area 6″, presents himself, in reverse, across from the ruts 17′ to get on the tray 12″, back up into the rear transfer position where the wheelchair 20″ is immobilized, the transfer himself onto the jump seat 19″, move forward toward the car door 33″, and move himself onto his motor vehicle seat. From there, he manually moves the jump seat backward, closes his car door 33″, and then can remotely control the withdrawal of the tray 12″ and the closure of the box. He then commands the opening of the gate 29″ and leaves the device.

1. A device for delivering personal vehicles to drivers with disabilities, comprising:
a box or container of the street furniture type having, at least on one side, an opening that can be opened and closed by a closure actuator controlled by a user, and containing a personal vehicle and a jump seat, positioned in respective positions withdrawn inside the box, and
respective transfer locations, in which the personal vehicle and the jump seat are next to and in close proximity to one another, said personal vehicle, when it is arranged in its transfer location, being kept in that location by a blocking device releasable by the user, said movable jump seat being able to be moved over guides between a forward position situated next to and in the vicinity of the seat of the user's motor vehicle, stopped in its determined position, and its transfer location.

2. The device according to claim 1, further comprising a seat bottom designed to support the user and movable horizontally between a position on said jump seat and a position on said personal vehicle, along respective guides forming a trajectory allowing it to move when said vehicle and said jump seat are in their respective transfer locations.

3. The device according to claim 1, wherein said respective transfer locations are situated inside the box.

4. The device according to claim 1, wherein the guides of the jump seat are completely contained inside the box.

5. The device according to claim 1, wherein the closure actuator of the box frees an access opening, both on the front of the box and on its lateral side close to the motor vehicle.

6. The device according to claim 1, wherein the transfer positions are at least partially outside the box, in front of it, the device further comprising a moving structure for moving both the personal vehicle and the jump seat, between their respective positions inside the box or container and respective transfer locations outside on its surface extending in front of the closing side of the box, and one side of which extends parallel to and at a small distance from the side of the motor vehicle door by which the user will exit, when the motor vehicle is in a predetermined stop position, transfer locations in which the wheelchair and the jump seat are located next one another and in close proximity to one another, said personal vehicle, when it is positioned at its transfer location, being kept in that location by a fastener releasable by the user, said movable jump seat being able to be moved forward to a forward position situated next to and in the vicinity of the seat of the motor vehicle of the user, stopped in its predetermined position.

7. The device according to claim 1, further comprising, inside or outside and in front of the box, guides of the personal vehicle having a shape facilitating the reverse return of the personal vehicle bearing the user, in order to return it exactly to said transfer location of the vehicle.

8. The device according to claim 1, further comprising a motor for driving the jump seat on its guide and a controller related thereto, controllable by the user.

9. The device according to claim 1, wherein said guide is substantially parallel, or at most slightly oblique relative to the longitudinal axis of the motor vehicle.

10. The device according to claim 1, wherein said guide is oblique toward the side and front of the motor vehicle.

11. The device according to claim 1, wherein the jump seat includes means for vertical movement of the seat bottom, allowing a variation in the vertical level of the seat bottom and vice versa, at least between two levels, namely, the seat bottom level of the personal vehicle and the seat level of the motor vehicle, if it is different.

12. The device according to claim 2, wherein the jump seat bears a structure or carriage that is movable relative to the jump seat, movable laterally toward the seat of the motor vehicle when the jump seat is in its forward position and provided, at least toward its end on the seat side, a support rolling on the ground, this movable structure having guides for the movement of the seat bottom on the jump seat.

13. The device according to claim 1, further comprising a sensor for detecting the open position of the door of the motor vehicle when stopped, causing the movement of the jump seat to stop at a predetermined fixed distance from the car door.

14. The device according to claim 1, further comprising:
a sensor for detecting a presence on the trajectory of the jump seat causing the stop of the jump seat, if a presence is detected,
a sensor for detecting the fixed or released state of the personal vehicle in the box,
a sensor for detecting the position of the seat bottom, in particular its position on the jump seat and its position on the wheelchair or personal vehicle,
a sensor for detecting the presence or absence of a driver on the seat bottom,
a detection or positioning sensor for the motor vehicle in its stopped position,
a camera allowing an operator situated remotely to view the device and the motor vehicle, or a microphone-speaker system to communicate with the user.

15. A method for using the device according to claim 1 for the delivery of personal vehicles, in particular wheelchairs or scooters for persons with disabilities, to said drivers with disabilities, in which, once the device is in place, and connected, if necessary, to the power sector, each user is assigned remote control means detectable by a sensor sensitive to said control means when it is in close proximity, the device being associated with computerized management means providing:
detection of the presence of the motor vehicle,
detection of the open position of the open car door, relative to the device,
detection of an obstacle or any presence on the surface traveled by the trajectory of the jump seat and/or the trajectory of the closure(s),
opening of the box,
exit of the jump seat, then its immobilization in its forward position,
detection of the presence of the user on the seat bottom situated on the jump seat,
return of the jump seat, then its immobilization in its transfer location next to the personal vehicle,
detection of the presence of the user on the seat bottom situated on the vehicle,
release of the personal vehicle and the observation of the departure of the personal vehicle from its predetermined location, and from the box, and
the closure of the box.
